(19) United States
(12) Patent Application Publication
(10) Pub. No.: US 2008/0066496 A1
(43) Pub. Date: Mar. 20, 2008

(54) Anisotropically shaped powder, related manufacturing method, and method of manufacturing crystal oriented ceramics

(75) Inventors: Toshiatsu Nagaya, Kuwana-shi (JP); Masaya Nakamura, Nagoya (JP); Tatsuhiko Nonoyama, Chiryu-shi (JP); Daisuke Shibata, Tokai-shi (JP); Hisaaki Takao, Seto-shi (JP); Yasuyoshi Saito, Toyota-shi (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/892,554

(22) Filed: Aug. 23, 2007

(30) Foreign Application Priority Data
Aug. 23, 2006 (JP) 2006-227069
Apr. 13, 2007 (JP) 2007-105785

(51) Int. Cl. C04B 35/495

(52) U.S. Cl. 65/17.4; 501/134

(57) ABSTRACT

An anisotropically shaped powder composed of oriented grains with a specific crystal plane {100} of each crystal grain being oriented, a related manufacturing method and a method of manufacturing a crystal oriented ceramics using such an anisotropically shaped powder are disclosed. The anisotropically shaped powder includes a principal component of an isotropic perovskite-based pentavalent metal acid alkali compound represented by a general formula (1): (KₐNa₁₋ₐ)(Nb_{1-b}Ta_{b})O₃ (wherein 0≦a≦0.8 and 0.02≦b≦0.4). In manufacturing the anisotropically shaped powder, a bismuth-layer-like perovskite-based compound of a specific composition is acid treated; a source of K or the like is added to the resulting acid-treated substance; and the resulting mixture is heated.

### CROSS REFERENCE TO RELATED APPLICATIONS

This application is related to Japanese Patent Application Nos. 2006-227069 and 2007-105785, filed on Aug. 23, 2006 and Apr. 13, 2007, respectively, the contents of which are hereby incorporated by reference.

### BACKGROUND OF THE INVENTION

1. Technical Field of the Invention

The present invention relates to an anisotropically shaped powder composed of oriented grains with a specific crystal plane being oriented, the related manufacturing method and a method of manufacturing a crystal oriented ceramics using the anisotropically shaped powder.

2. Description of the Related Art

In the related art, there has been an increasing demand for a piezoelectric material and dielectric material having favorable piezoelectric characteristics and dielectric characteristics with no inclusion of lead acting as an environmental load substance. As the most likely candidate for such material, a crystal oriented ceramics of a family of (Li, K, Na)(Nb, Ta, Sb)O₃ plays a role as a promising material.

In particular, a crystal oriented ceramics has been developed in the form of an isotropic perovskite-based compound represented by a general formula: (K_{1-y}Na_{y})(Nb_{1-z-w}Ta_{z}Sb_{w})O₃ (wherein 0≦y≦1, 0≦z≦1 and 0≦w≦1) as disclosed in U.S. Pat. No. 6,692,652.

As disclosed in this related art, the crystal oriented ceramics can be manufactured by mixing a plate-like powder, represented by a general formula: {Liₓ(K_{1-y}Na_{y})₁₋ₓ} (Nb_{1-z-w}Ta_{z}Sb_{w})O₃ (wherein 0≦x≦1, 0≦y≦1, 0≦z≦1 and 0≦w≦1), a reactive material and a sintering aid (CuO) to provide a blended mixture, forming the blended mixture in sheet-like compact bodies, stacking the sheet-like compact bodies in multiple pieces to form a stacked body, press rolling the stacked body, degreasing the stacked body, executing cold isostatic pressing (CIP) treatment on the stacked body and heating the stacked body in atmosphere.

Further, the plate-like powder can be manufactured in a flux method using a bismuth-layer-like perovskite-based compound represented by a general formula: (Bi₂O₂)²⁺{Bi_{0.5}AM_{m-1.5}NbₘO₃ₘ₊₁}²⁻ (wherein “m” is an integer number greater than 2 and AM represents at least one of Na, K and Li).

As disclosed in U.S. Patent Application Publication No. 2004/0214723, furthermore, an isotropic perovskite-based crystal oriented ceramics has been developed in a composition represented by a general formula: {Liₓ(K_{1-y}Na_{y})₁₋ₓ}(Nb_{1-z-w}Ta_{z}Sb_{w})O₃ (wherein 0≦x≦0.2, 0≦y≦1, 0≦z≦0.4 and 0≦w≦0.2 and x+z+w>0).

In manufacturing such crystal oriented ceramics, use was made of a plate-like powder composed of NaNbO₃. In particular, the plate-like powder and a reactive raw material were mixed, thereby obtaining a mixture. Then, the mixture was formed in sheets. The resulting multiple sheets were stacked to form a stacked body. Subsequently, the stacked body was press rolled, greased and subjected to a cold isostatic pressing (CIP) treatment. The resulting stacked body was then heated in atmosphere, thereby providing the crystal oriented ceramics.

With the related art method of manufacturing the crystal oriented ceramics using the plate-like powder, represented by the general formula: {Liₓ(K_{1-y}Na_{y})₁₋ₓ} (Nb_{1-z-w}Ta_{z}Sb_{w})O₃ (wherein 0≦x≦1, 0≦y≦1, 0≦z≦1 and 0≦w≦1), as a template, a need arises for using a relatively large amount of sintering aid. The use of such a large amount of sintering aid results in a fear of a drop occurring in the piezoelectric of the resulting crystal oriented ceramics.

With the related art method of manufacturing the crystal oriented ceramics of the family in the composition of (Li, K, Na)(Nb, Ta, Sb)O₃ using the plate-like powder composed of NaNbO₃, a need arises for performing temperature controls during reactive heating between the plate-like powder and the reactive material for the purpose of obtaining the crystal oriented ceramics having high density as high as, for instance, 95% or more with increased orientation degree as high as, for instance, 80% or more.

In particular, the temperature controls need to perform a slow cooling method and a two-stage combustion method. In the slow cooling method, during a drop in temperature after the material has been heated, the temperature of the material is lowered from a maximal temperature to a lower temperature, less than the maximal temperature by 100° C., at a temperature drop rate of 20° C./h. In the two-stage combustion method, the material is kept at the maximal temperature during a heating stage and, in addition thereto, maintained at a temperature lower than the maximal temperature by 20 to 100° C. for 5 to 10 hours.

This results in an increase in time required for the production of the crystal oriented ceramics, causing a fear occurring in an increase in production cost.

When synthesizing the plate-like powder composed of NaNbO₃ in the flux method, a large volume of surplus Bi₂O₃ is generated. Therefore, the plate-like powder of NaNbO₃ results in a mass that needs to be mechanically pulverized in a mortar. Thus, an issue arises with the occurrence of causing the plate-like powder shape to result in a finely divided powder. In addition, as the large volume of surplus Bi₂O₃ is generated, the plate-like powder of NaNbO₃ gets rough in surface, causing an issue to arise with a difficulty encountered for the plate-like powder to be oriented against a shear stress present on a stage of forming the plate-like powder in an oriented state.

Moreover, these operations need troublesome steps such as the heat treatment, the pulverizing and the removing of flux, causing an issue to arise with the occurrence of an increase in production cost.

Further, when manufacturing the crystal oriented ceramics using the plate-like powder of the related art, the stacked body, resulting from the degreasing step, was subjected to the cold isostatic press (CIP) treatment and firing treatment in oxygen with a view to increasing density. Moreover, for the purpose of increasing the orientation degree, the stacked body was subjected to press rolling treatment. With the operations such as the CIP treatment, the oxygen firing treatment and the press rolling treatment being implemented, an issue arises with the occurrence of an increase in production cost of the crystal oriented ceramics.

### SUMMARY OF THE INVENTION

The present invention has been completed with a view to addressing the above issues and has an object to provide an anisotropically shaped powder, used in manufacturing a crystal oriented ceramics with high density and orientation degree on an excellent mass production basis, the related manufacturing method and a method of manufacturing a crystal oriented ceramics.

To achieve the above object, a first aspect of the present invention provides an anisotropically shaped powder comprising an anisotropically shaped powder composed of oriented grains with a specific crystal plane {100} of each crystal grain being oriented, and the anisotropically shaped powder including a principal component of an isotropic perovskite-based pentavalent metal acid alkali compound represented by a general formula (1): (KₐNa₁₋ₐ)(Nb_{1-b}Ta_{b})O₃ (wherein 0≦a≦0.8 and 0.02≦b≦0.4).

The anisotropically shaped powder is composed of the oriented grains including a main component of the pentavalent metal acid alkali compound in a specified composition expressed by the above formula.

The anisotropically shaped powder may be used as a template when manufacturing a crystal oriented ceramics. To this end, the anisotropically shaped powder and a reactive material, reacting with the anisotropically shaped powder, are mixed. The resulting mixture is shaped such that the plane {100} of the anisotropically shaped powder is oriented and, then, heated. This enables the production of the crystal oriented ceramics with a specific crystal plane of each crystal grain being oriented.

Further, the anisotropically shaped powder contains Na, Nb, Ta as essential metal elements as expressed in the formula described above. In addition, the anisotropically shaped powder has a principal component of the pentavalent metal acid alkali compound in a specified composition that can further selectively contain K. Therefore, when manufacturing the crystal oriented ceramics the use of the anisotropically shaped powder, the crystal oriented ceramics can be manufactured in a structure with increased density and high degree of orientation with no need of performing the slow cooling method and the two-stage combustion method as required in the prior art. Moreover, the use of the anisotropically shaped powder enables the crystal oriented ceramics to be easily densified. Thus, almost no need arises for using a sintering aid. This results in a capability of addressing defects such as degradation in a piezoelectric characteristic of the crystal oriented ceramics. Further, the use of the anisotropically shaped powder enables the crystal oriented ceramics to have high degree of orientation and high density without performing the press rolling treatment, the cold isostatic treatment and the oxygen firing as required in the related art. Furthermore, this addresses the issue of adverse affect on a surface condition of the plate-like powder due to the occurrence of fine powder and the large amount of Bi₂O₃ generated in excess that would occur when using the plate-like powder NaNbO₃ of the related art.

Further, in a case where a crystal oriented ceramics is manufactured in a complicated composition such as the family of (Li, K, Na)(Nb, Ta)O₃ using the related art plate-like powder composed of NaNbO₃, a variation is liable to occur in a distribution on a part of elements such as K and Ta or the like forming the crystal oriented ceramics. In contrast, the use of the anisotropically shaped powder of the first aspect of the present invention set forth above enables the provision of the crystal oriented ceramics with less variation in elements constituting the crystal oriented ceramics.

A second aspect of the present invention provides a method of manufacturing an anisotropically shaped powder having a principal component of an isotropic perovskite-based pentavalent metal acid alkali compound, represented by the general formula (1): (KₐNa₁₋ₐ)(Nb_{b-1}Ta_{b})O₃ (wherein 0≦a≦0.8 and 0.02≦b≦0.4), which has crystal grains with a specific crystal plane {100} of each crystal grain being oriented. The method comprises the steps of preparing an anisotropically shaped starting raw material powder composed of a bismuth-layer-like perovskite-based compound represented by a general formula (3): (Bi₂O₂)²⁺(Bi_{0.5}(K_{c}Na_{1-c})_{m-1.5}(Nb_{1-b}Ta_{b})ₘO₃ₘ₊₁)²⁻ (wherein “m” is an integer number greater than 2 and 0≦c≦0.8 and 0.02≦b≦0.4), acid-treating the anisotropically shaped starting raw material powder for obtaining an acid-treated substance, adding at least a source of K and/or a source of Na to the acid-treated substance to form a mixture, and heating the mixture in a flux composed of a principal component containing NaCl and/or KCl for thereby obtaining the anisotropically shaped powder.

The manufacturing method of the second aspect of the present invention includes the acid-treatment step and the heating step.

In the acid-treatment step, the starting raw material powder in the form of an anisotropic shape, represented by the general formula (3) described above, is acid treated. Then, in the heating step, at least the source of K and/or the source of Na are added to the resulting acid treated substance and the resulting mixture is heated in the flux composed of the principal component containing NaCl and/or KCl. This result in the production of the anisotropically shaped powder represented by the general formula (1) set forth above. Using such an anisotropically shaped powder enables a crystal oriented ceramics to be simply manufactured in a structure with increased density and orientation degree as set forth above.

The acid-treatment step enables the elimination of bismuth of the bismuth-layer-like perovskite-based compound represented by the general formula (3). In addition, in the acid treatment step, there are defects such as a Na-defect and/or K-defect. In the heating step, the Na-defect and/or K-defect, resulting from the acid-treatment step, can be substituted with alkali elements, that is, Na and/or K. As a result, the anisotropically shaped powder can be simply obtained in the composition represented by the general formula (1).

A third aspect of the present invention provides a method of manufacturing an anisotropically shaped powder, composed of a principal component of an isotropic perovskite-based pentavalent metal acid alkali compound represented by a general formula (4): (K_{d}Na_{1-d})(Nb_{1-b}Ta_{b})O₃ (wherein 0<d≦0.8 and 0.02≦b≦0.4), which includes oriented grains with a specific crystal plane {100} of each crystal grain being oriented. The method comprises the steps of preparing an anisotropically shaped starting raw material powder, composed of a principal component of an isotropic perovskite-based pentavalent metal acid alkali compound represented by a general formula (5): Na(Nb₁₋ₑTaₑ)O₃ (wherein 0.02≦e≦0.4), which includes oriented grains with a specific crystal plane {100} of each oriented grain being oriented, adding at least a source of K to the anisotropically shaped starting raw material powder to form a raw material mixture, and heating the raw material mixture in a flux composed of a principal component containing KCl for thereby obtaining the anisotropically shaped powder.

The manufacturing method of the third aspect of the present invention includes the preparing step and the heating step.

In the preparing step, the anisotropically shaped starting raw material powder is prepared in the composition represented by the general formula (5). Then, in the heating step, at least the source of K is added to the anisotropically shaped starting raw material powder and the resulting mixture is heated in the flux having the principal component of KCl. This results in the production of the anisotropically shaped powder represented by the general formula (4). Using the anisotropically shaped powder allows a crystal oriented ceramics to be simply manufactured in a structure with increased density and orientation degree. In addition, the anisotropically shaped powder, represented by the general formula (4) that can be manufactured with the method of the third aspect of the present invention, corresponds to the anisotropically shaped powder manufactured with the first and second aspects of the present invention when a≠0 in the general formula (1) described above. That is, the manufacturing method of the third aspect of the present invention can be applied to a case where the anisotropically shaped powder is manufactured in a composition with a≠0 in the general formula (1) described above.

A fourth aspect of the present invention provides a method of manufacturing an anisotropically shaped powder, composed of a principal component of an isotropic perovskite-based pentavalent metal acid alkali compound represented by general formula (6): (KₐNa₁₋ₐ)NbO₃ (wherein 0≦a≦0.8), which includes oriented grains with a specific crystal plane {100} of each crystal grain being oriented. The method comprises the steps of preparing an anisotropically shaped starting raw material powder, composed of a principal component of a bismuth-layer-like perovskite-based compound represented by a general formula (7): (Bi₂O₂)²⁺{Bi_{0.5}(K_{c}Na_{1-c})_{m-0.5}(NbₘO₃ₘ₊₁}²⁻ (wherein “m” is an integer number greater than 2 and 0≦c≦0.8), which includes oriented grains with a specific crystal plane {100} of each oriented grain being oriented, acid-treating the anisotropically shaped starting raw material powder for obtaining an acid-treated substance, adding at least a source of K and/or a source of Na to the acid-treated substance to form an acid-treated mixture, and heating the acid-treated mixture in a flux composed of a principal component containing NaCl and/or KCl for thereby obtaining the anisotropically shaped powder.

The manufacturing method of the fourth aspect of the present invention includes the acid-treatment step and the heating step.

In the acid-treatment step, the starting raw material powder in the form of an anisotropic shape, represented by the general formula (7) described above, is acid treated. Then, in the heating step, at least the source of K and/or the source of Na are added to the resulting acid treated substance and the resulting mixture is heated in the flux composed of the principal component containing NaCl and/or KCl. This result in the production of the anisotropically shaped powder represented by the general formula (6) set forth above. Using such an anisotropically shaped powder enables a crystal oriented ceramics to be simply manufactured in a structure with increased density and orientation degree as set forth above. In addition, the anisotropically shaped powder, represented by the general formula (6) that can be manufactured with the method of the fourth aspect of the present invention, corresponds to the anisotropically shaped powder manufactured with the first and second aspects of the present invention when b=0 in the general formula (1) described above. That is, the manufacturing method of the fourth aspect of the present invention can be applied to a case where the anisotropically shaped powder is manufactured in a composition with b=0 in the general formula (1) described above.

The acid-treatment step enables the elimination of bismuth of the bismuth-layer-like perovskite-based compound represented by the general formula (7) like the second aspect of the present invention. Further, in the acid treatment step, there occur defects such as a Na-defect and/or K-defect like the result of the second aspect of the present invention. In the heating step, the Na-defect and/or K-defect, resulting from the acid-treatment step, can be substituted with alkali elements, that is, Na and/or K. As a result, the anisotropically shaped powder can be simply obtained in the composition represented by the general formula (6).

A fifth aspect of the present invention provides a method of manufacturing an anisotropically shaped powder, composed of a principal component of an isotropic perovskite-based pentavalent metal acid alkali compound represented by a general formula (8): (K_{f}Na_{1-f})NbO₃ (wherein 0<f≦0.8), which includes oriented grains with a specific crystal plane {100} of each crystal grain being oriented. The method comprises the steps of preparing an anisotropically shaped starting raw material powder, composed of a principal component of NaNbO₃, which includes oriented grains with a specific crystal plane {100} of each oriented grain being oriented, adding at least a source of K to the anisotropically shaped starting raw material powder to form a raw material mixture, and heating the raw material mixture in a flux composed of a principal component containing KCl for thereby obtaining the anisotropically shaped powder.

The manufacturing method of the fifth aspect of the present invention includes the preparing step and the heating step.

In the preparing step, the anisotropically shaped starting raw material powder is prepared in the composition having the principal component of NaNbO₃. Then, in the heating step, at least the source of K is added to the anisotropically shaped starting raw material powder and the resulting mixture is heated in the flux having the principal component of KCl. This results in the production of the anisotropically shaped powder represented by the general formula (8). Using the anisotropically shaped powder allows a crystal oriented ceramics to be simply manufactured in a structure with increased density and orientation degree. In addition, the anisotropically shaped powder, represented by the general formula (8) that can be manufactured with the method of the fifth aspect of the present invention, corresponds to the anisotropically shaped powder manufactured with the first and second aspects of the present invention when a≠0 and b=0 in the general formula (1) described above. That is, the manufacturing method of the fifth aspect of the present invention can be applied to a case where the anisotropically shaped powder is manufactured in a composition with a≠0 and b=0 in the general formula (1) described above.

A sixth aspect of the present invention provides a method of manufacturing a crystal oriented ceramics having a polycrystal substance with a main phase having an isotropic perovskite-based compound, represented by a general formula (2): (Liₓ(K_{1-y}Na_{y})₁₋ₓ} (Nb_{1-z-w}Ta_{z}Sb_{w})O₃ (wherein 0≦x≦0.2, 0≦y≦1, 0≦z≦0.4, 0≦w≦0.2 and x+z+w>0), which includes oriented grains with a specific crystal plane {100} of each crystal grain constituting the polycrystal substance being oriented. The method comprises the steps of mixing an anisotropically shaped powder and a reactive material, reacting with the anisotropically shaped powder to provide the isotropic perovskite-based compound represented by the general formula (2), to prepare a raw material mixture, forming the raw material mixture into a compact body so as to allow the anisotropically shaped powder to have crystal planes {100} oriented in substantially the same direction, and firing the compact body upon heating the same for reacting the anisotropically shaped powder and the reactive material with each other for sintering to form the crystal oriented ceramics. The anisotropically shaped powder includes the anisotropically shaped powder defined in claim 1 or the anisotropically shaped powder defined in any one of claims 3 to 12.

A seventh aspect of the present invention provides a method of manufacturing a crystal oriented ceramics, composed of a polycrystal substance with a main phase having an isotropic perovskite-based compound represented by a general formula (2): {Liₓ(K_{1-y}Na_{y})₁₋ₓ} (Nb_{1-z-w}Ta_{z}Sb_{w})O₃ (wherein 0≦x≦0.2, 0≦y≦1, 0≦z≦0.4, 0≦w≦0.2 and x+z+w>0), which includes oriented grains with a specific crystal plane {100} of each crystal grain constituting the polycrystal substance being oriented. The method comprises the steps of mixing an anisotropically shaped powder and a reactive material, reacting with the anisotropically shaped powder to provide the isotropic perovskite-based compound represented by the general formula (2), to prepare a raw material mixture, forming the raw material mixture into a compact body so as to allow the anisotropically shaped powder to have crystal planes {100} oriented in substantially the same direction, and firing the compact body upon heating the same for reacting the anisotropically shaped powder and the reactive material with each other for sintering to form the crystal oriented ceramics. The anisotropically shaped powder includes an acid-treated substance obtained by acid treating an anisotropically shaped starting raw material powder composed of a bismuth-layer-like perovskite-based compound represented by a general formula (9): (Bi₂O₂)²⁺{Bi_{0.5}(K_{c}Na_{1-c})_{m-1.5}(Nb_{1-g}Ta_{g})ₘO₃ₘ₊₁}²⁻ (wherein “m” is an integer number greater than 2, 0≦c≦0.8and 0≦g≦0.4).

Each of the sixth and seventh aspects of the present invention includes the mixing step, the forming step and the firing step. With the sixth aspect of the present invention, the anisotropically shaped powder includes an acid-treated substance obtained by acid treating the anisotropically shaped starting raw material powder composed of the bismuth-layer-like perovskite-based compound represented by the general formula (9): (Bi₂O₂)²⁺{Bi_{0.5}(K_{c}Na_{1-c})_{m-1.5}(Nb_{1-g}Ta_{g})ₘO₃ₘ₊₁}²⁻ (wherein “m” is an integer number greater than 2 and 0≦c≦0.8 and 0≦g≦0.4).

The use of the anisotropically shaped powder enables the crystal oriented ceramics to be manufactured in a structure with increased density and high degree of orientation with no need of performing the slow cooling method and the two-stage combustion method as required in the prior art. Moreover, the use of the anisotropically shaped powder enables the crystal oriented ceramics to be easily densified. Thus, almost no need arises for using a sintering aid. This results in a capability of addressing defects such as degradation in a piezoelectric characteristic of the crystal oriented ceramics. Further, the use of the anisotropically shaped powder enables the crystal oriented ceramics to have high degree of orientation and high density without performing the press rolling treatment, the cold isostatic treatment and the oxygen firing as required in the related art. Furthermore, this addresses the issue of adverse affect on a surface condition of the plate-like powder due to the occurrence of fine powder and the large amount of Bi₂O₃ generated in excess that would occur when using the plate-like powder NaNbO₃ of the related art. In addition, the crystal oriented ceramics has a composition close to that of the reactive material in contrast to the plate-like powder of the NaNbO₃ of the related art, resulting in a capability of having increased homogeneity in composition of the crystal oriented ceramics.

As a consequence, with the sixth and seventh aspects of the present invention, the crystal oriented ceramics can be manufactured in a composition with excellent homogeneity. Moreover, the crystal oriented ceramics can have excellent homogeneity in composition.

### BRIEF DESCRIPTION OF THE DRAWINGS

FIG. 1 is a drawing substitute photograph taken by a scanning electron microscope (SEM) showing a surface figure of an anisotropically shaped powder prepared in Example 1 of the present invention.

FIG. 2 is a drawing substitute photograph taken by the scanning electron microscope (SEM) showing a surface figure of an anisotropically shaped powder prepared in Example 2 of the present invention.

FIG. 3 is a drawing substitute photograph taken by the scanning electron microscope (SEM) showing a surface figure of an anisotropically shaped powder prepared in Example 3 of the present invention.

FIG. 4 is a drawing substitute photograph taken by the scanning electron microscope (SEM) showing a surface figure of an anisotropically shaped powder prepared in Example 5 of the present invention.

FIG. 5 is a drawing substitute photograph taken by the scanning electron microscope (SEM) showing a surface figure of an anisotropically shaped powder prepared in Comparative Example.

FIG. 6 is a drawing substitute photograph taken by the scanning electron microscope (SEM) showing a surface figure of an anisotropically shaped powder prepared in Example 6 of the present invention.

FIG. 7 is a drawing substitute photograph taken by the scanning electron microscope (SEM) showing a surface figure of an anisotropically shaped powder prepared in Example 7 of the present invention.

FIG. 8 is a drawing substitute photograph taken by the scanning electron microscope (SEM) showing a surface figure of an anisotropically shaped powder prepared in Example 8 of the present invention.

FIG. 9 is a drawing substitute photograph taken by the scanning electron microscope (SEM) showing a surface figure of an anisotropically shaped powder prepared in Example 9 of the present invention.

FIG. 10 is a graph showing a concentration distribution (on a concentration in terms of at. % and a sum of K and Na constituting an A-site element) of K contained in various specimens (of a specimen E3, a specimen C1 and a specimen C3) manufactured as experimental examples.

FIG. 11 is a graph showing a concentration distribution (on a concentration in terms of at. % and a sum of Nb, Ta and Sb constituting a B-site element) of Ta contained in various specimens (of a specimen E3, a specimen C1 and a specimen C3) manufactured as experimental examples.

### DETAILED DESCRIPTION OF PREFERRED EMBODIMENTS

Now, an anisotropically shaped powder, a related manufacturing method and a method of manufacturing a crystal oriented ceramics using such anisotropically shaped powder according to various aspects of the present invention will be described below in detail with reference to the accompanying drawings. However, the present invention is construed not to be limited to such aspects of the present invention described below and technical concepts of the present invention may be implemented in combination with other known technologies or the other technology having functions equivalent to such known technologies.

### First Aspect of Invention

Now, an anisotropically shaped powder of a first aspect of the present invention is described below in detail.

According to the first aspect of the present invention, the anisotropically shaped powder includes a principal component of an isotropic perovskite-based pentavalent metal acid alkali compound represented by a general formula (1): (KₐNa₁₋ₐ)(Nb_{1-b}Ta_{b})O₃ (wherein 0≦a≦0.8 and 0.02≦b≦0.4).

The anisotropically shaped powder, formed in such a composition, can be used in manufacturing a crystal oriented ceramics composed of crystal grains with a specific crystal plane of each crystal grain constituting the polycrystal being oriented.

In manufacturing the crystal oriented ceramics using such an anisotropically shaped powder mentioned above, the following steps are carried out in a manner described below.

That is, first, a reactive raw material, reactive with the anisotropically shaped powder during heating, is prepared. The anisotropically shaped powder and the reactive raw material are mixed, thereby forming a raw material mixture.

Then, the raw material mixture is formed in suitable structures such as, for instance, sheets, which in turn are formed into a compact body such that crystal planes {100} of the anisotropically shaped powder are oriented in the substantially same direction. Subsequently, the compact body is heated to cause the anisotropically shaped powder and the reactive raw material to react with each other, enabling a crystal oriented ceramics to be obtained in a target composition.

With the present invention, as used herein, the term “anisotropically shaped” refers to the meaning representing that a component has a greater dimension in a longitudinal axis than that of a lateral axis or thickness direction. In particular, examples of the “anisotropically shaped” configuration may preferably include a plate-like shape, a columnar shape, a scale-like shape and a needle-like shape, etc.

Examples of the oriented grains may preferably include those having a shape to be easily oriented in a certain direction on a stage of a forming step. Therefore, the oriented grains may preferably have an average aspect ratio greater than 3. If the average aspect ratio is less than 3, it becomes hard for the anisotropically shaped powder to be oriented in one direction. In order to obtain the crystal oriented ceramics with a further increased degree of orientation, the oriented grains may preferably have an aspect ratio greater than 5. As used herein, the term “aspect ratio” refers to an average value of a maximal-dimension/minimal-dimension of each oriented grain.

Further, it is likely that the larger the average aspect ratio of the oriented grain, the easier will be the oriented grain to be oriented in one direction during the forming step. However, if the oriented grains have a large average aspect ratio in excess, there is a fear of the oriented grains rupturing during the mixing step. This results in a difficulty of achieving the forming step to obtain the compact body with the oriented grains remained oriented. Consequently, the oriented grains may preferably have an average aspect ratio less than 100. This value may preferably lie in a value less than 50 and, more preferably, a value less than 30.

Further, when manufacturing a crystal oriented ceramics using the oriented grains as achieved by the sixth and seventh aspects of the present invention, the oriented grains and the reactive raw material are caused to react with each other and sintered during a firing step for thereby forming the crystal oriented ceramics. In this case, if the oriented grains have large sizes in excess, then, the crystal grains glow in a large size. This causes a fear to arise with the occurrence of a drop in strength of the crystal oriented ceramics. Accordingly, the oriented grain may preferably have a longitudinal maximal dimension less than 30 μm. The longitudinal maximal dimension of the oriented grain may be further preferably less than 20 μm and, more preferably, less than 15 μm. Moreover, if the oriented grains have small sizes in excess, then, the crystal grains glow in a small size, causing a fear to arise with the occurrence of degradation in a piezoelectric characteristic of the resulting crystal oriented ceramics. Accordingly, the oriented grain may preferably have a longitudinal maximal dimension greater than 0.5 μm. The longitudinal maximal dimension of the oriented grain may be further preferably less than 1 μm and, more preferably, less than 2 μm.

With the present invention, further, the anisotropically shaped powder may be preferably used for manufacturing a crystal oriented ceramics upon mixing the anisotropically shaped powder with a reactive raw material, reacting with the anisotropically shaped powder, to form a raw material mixture. The raw material mixture is then heated to provide the crystal oriented ceramics composed of a polycrystal substance including an isotropic perovskite-based compound with a main phase represented by a general formula (2): Liₓ(K_{1-y}Na_{y})₁₋ₓ}(Nb_{1-z-w}Ta_{z}Sb_{w})O₃ (wherein 0≦x≦0.2, 0≦y≦1, 0≦z≦0.4, 0≦w≦0.2, x+z+w>0) wherein a crystal grain constituting the polycrystal substance has a crystal plane {100} that is oriented.

In this case, using the anisotropically shaped powder enables the crystal oriented ceramics to be obtained in the composition, represented by the general formula (2) set forth above, which has high density and high degree of orientation with increased piezoelectric characteristics.

As used herein, the expression “specific crystal plane is oriented” is meant by the fact that respective crystal grains are oriented under a state (hereinafter referred to as “plane orientation”) wherein specific crystal planes of the perovskite-based compound are aligned on planes parallel to each other.

Further, in a case where the perovskite-based compound has a tetragonal crystal system, the specific crystal plane may be preferably oriented in a pseudocubic {100} plane. This results in a further increase in the piezoelectric characteristics or the like of the crystal oriented ceramics.

As used herein, the term “pseudocubic {HKL}” is meant by the fact that the isotropic perovskite-based compound generally is slightly distorted in structure from a cubic crystal such as a tetragonal crystal, an orthorhombic crystal and a trigonal crystal, etc., and such a distortion occurs within a few range whereby the isotropic perovskite-based compound is regarded to be the cubic crystal and displayed in Miller Indices.

With the specific crystal planes structured in the plane orientation, the degree of plane orientation can be expressed in an average degree of orientation F (HKL) based on a Lotgering method expressed by the following Formula (1):

$$F ( HKL ) = \frac{\frac{{\sum }^{′} I ( HKL )}{\sum I ( hkl )} - \frac{{\sum }^{′} {I}_{0} ( HKL )}{\sum {I}_{0} ( hkl )}}{1 - \frac{{\sum }^{′} {I}_{0} ( HKL )}{\sum {I}_{0} ( hkl )}} ⨯ 100 ( \% ) \qquad [ Formula 1 ]$$

In Formula (1), ΣI (hkl) represents a total sum of the X-ray diffraction intensity of entire crystal planes (hkl) measured for the crystal oriented ceramics. ΣI₀ (hkl) represents a total sum of the X-ray diffraction intensity of entire crystal planes (hkl) measured for non-oriented piezoelectric ceramics having the same composition as that of the crystal oriented ceramics. Further, ΣI (HKL) represents a total sum of the X-ray diffraction intensity of specified crystal planes (HKL) being crystallographically equivalent to those of the crystal oriented ceramics. ΣI₀(HKL) represents the total sum of the X-ray diffraction intensity crystallographically equivalent to those measured for the non-oriented piezoelectric ceramics having the same composition as that of the crystal oriented ceramics.

Accordingly, under a circumstance where the crystal grains, forming the polycrystal, are formed in a non-oriented structure, an average orientation F (HKL) lies at 0%. Furthermore, in a case where the planes (HKL) of the crystal grains forming the polycrystal are oriented in parallel to measured surfaces, the average orientation F (HKL) lies at 100%.

The crystal oriented ceramics glows such that the greater the proportion of the oriented crystal grains, the higher will be the characteristics. In order to obtain the high piezoelectric characteristic when causing, for instance, the specific crystal planes to be oriented, the average orientation degree F (HKL), based on the Lotgering method expressed in the formula (1), may preferably have a value greater than 80%. More preferably, the average orientation degree F (HKL) may have a value greater than 90%.

Further, the specific crystal plane to be oriented may preferably include a plane perpendicular to a polarization axis.

With the first aspect of the present invention, the anisotropically shaped powder has a principal component composed of an isotropic perovskite-based pentavalent metal acid alkali compound represented by a general formula (1): (KₐNa₁₋ₐ)(Nb_{1-b}Ta_{b})O₃ (wherein 0≦a≦0.8 and 0.02≦b≦0.4) wherein a specific crystal plane of each crystal grain constituting the polycrystal is oriented.

In the above formula (1), if a>0.8, a drop occurs in a melting point of the anisotropically shaped powder. This causes a fear to arise with a difficulty of obtaining a crystal oriented ceramics with increased degree of orientation when manufacturing the crystal oriented ceramics using the anisotropically shaped powder. In addition, if b<0.02, there is a need for the press-rolling or CIP treatment or the like to be performed as required in the related art with a view to obtaining the crystal oriented ceramics with high density and high degree of orientation.

Meanwhile, if b>0.4, the crystal oriented ceramics, obtained using the anisotropically shaped powder, has a large content of Ta in excess. This causes a drop to occur in Curie temperature. Thus, there is a fear to arise with a difficulty in utilizing such a material as a piezoelectric material of electrical appliances and automotive component parts operating under high temperature environments.

### Second Aspect of Invention

The manufacturing method of a second aspect of the present invention includes an acid-treating step and a heating step. The acid-treating step and the heating step are executed to manufacture an anisotropically shaped powder comprised of a principal component including an isotropic perovskite-based pentavalent metal acid alkali compound represented by the general formula (1): (KₐNa₁₋ₐ)(Nb_{1-b}Ta_{b})O₃ (wherein 0≦a≦0.8 and 0.02≦b≦0.4) and including crystal grains with a specific crystal plane of each crystal grain being oriented.

In the acid-treating step, an acid-treated substance is obtained by acid treating an anisotropically shaped starting raw material powder composed of a bismuth-layer-like perovskite-based compound represented by a general formula (3): (Bi₂O₂)²⁺(Bi_{0.5}(K_{c}Na_{1-c})_{m-1.5}(Nb_{1-b}Ta_{b})ₘO₃ₘ₊₁)²⁻ (wherein “m” is an integer number greater than 2 and 0≦c≦0.8 and 0.02≦b≦0.4).

A value of “b” in the above general formula (3) has the same value as that of “b” in the above general formula (1). That is, for the starting raw material powder, use is made of the bismuth-layer-like perovskite-based compound that has an atomic ratio of Nb and Ta equivalent to that of the anisotropically shaped powder of the target composition represented by the general formula (1) set forth above.

If values of “b” or “c” are out of the specified ranges in the general formula (3), there is a fear of a difficulty of obtaining the anisotropically shaped powder in the target composition represented by the general formula (1).

In addition, if a value of “m” increases in excess, there is another fear arising in a synthesizing step wherein non-anisotropic perovskite powder particles occur in addition to the formation of the anisotropically shaped powder in the composition of the bismuth-layer-like perovskite-based compound. Accordingly, the value of “m” may preferably lie in an integer number less than 15 in view of increasing a yield ratio of the anisotropically shaped powder.

Further, the acid treatment can be conducted upon bringing the starting raw material into contact with, for instance, acid such as hydrochloric acid or the like. In particular, the acid treatment may preferably include, for instance, steps of heating the starting raw material in acid and mixing the starting raw material while heating the same.

In the heating step, furthermore, at least a source of K and/or source of Na are added to the acid-treated substance to provide a mixture, which in turn is heated in a flux including a principal component composed of NaCl and/or KCl.

Examples of the source of K may preferably include a compound containing at least an element K such as, for instance, K₂CO₃ and KHCO₃ or the like. Moreover, examples of the source of Na may preferably include a compound containing at least n element of Na such as, for instance, Na₂CO₃ and NaHCO₃ or the like.

In addition, the source of K and/or source of Na may be preferably added to the acid-treated substance at a ratio of 1 to 5 mol in a sum of the element K and the element Na contained in the source of K and/or source of Na per 1 mol of the bismuth-layer-like perovskite-based compound represented by the general formula (3).

With the bismuth-layer-like perovskite-based compound subjected to the acid treatment, a bismuth layer is dissolved in acid with the occurrence of hydrogen substitution and bismuth, contained in a perovskite layer, is dissolved in acid. In addition, at the same time, at least a part of K and/or Na in the perovskite layer is dissolved in acid. This enables the formation of Na-defect and/or K-defect. As a result, the acid-treated substance has a complicated structure containing a structure of a perovskite-based compound. In this case, if the acid-treated substance is identified as a perovskite-based composition ABO_{α}, then, the relationship is established as A/B=0.35 to 0.65 (wherein A is a total mol number of K and Na, B is a total mol number of Nb and Ta and α is expressed as 2<α<4.5). Accordingly, if a sum of the element K and the element Na contained in the source of K and/or the source of Na is less than 1 mol, a difficulty is encountered for the Na-defect and/or the K-defect Na in the acid-treated substance to be sufficiently substituted with K and/or Na. As a result, there is a fear of an increase in the number of A-site defects in the pentavalent metal acid alkali compound represented by the general formula (1). Meanwhile, if a sum of the element K and the element Na contained in the source of K and/or source of Na is greater than 5 mol, then, the anisotropically shaped powder particles are likely to be fusion bonded to each other during the heating treatment in flux.

### Third Aspect of Invention

Next, a third aspect of the present invention will be described below.

According to the third aspect of the present invention, the manufacturing method includes the preparing step and the heating step for manufacturing an anisotropically shaped powder, composed of a principal component including an isotropic perovskite-based pentavalent metal acid alkali compound represented by a general formula (4): (K_{d}Na_{1-d})(Nb_{1-b}Ta_{b})O₃ (wherein 0<d≦0.8 and 0.02≦b≦0.4), which includes oriented grains with a specific crystal plane {100} of each crystal grain being oriented.

In the general formula (4), “d” and “b” have ranges that have the same criticality significances as those of the ranges “a” and “b” in the general formula (1). In addition, if d=0, the manufacturing method of the third aspect of the present invention cannot be applied.

In the preparing step described above, an anisotropically shaped starting raw material powder is prepared including a principal component, composed of an isotropic perovskite-based pentavalent metal acid alkali compound represented by a general formula (5): Na(Nb₁₋ₑTaₑ)O₃ (wherein 0.02≦e≦0.4), which includes oriented grains with a specific crystal plane {100} of each oriented grain being oriented.

In the general formula (5), “e” may take a value equal to or different from the value of “b” in the general formula (4). In the general formula (5), if e<0.02 or e>0.4, there is a fear of a difficulty encountered in obtaining the anisotropically shaped powder in the target composition represented by the general formula (4).

During the heating step described above, further, at least the source of K is added to the anisotropically shaped starting raw material powder to provide a mixture, which in turn is heated in a flux including a principal component of KCl.

Examples of the source of K may preferably include the same component as that used in the second aspect of the present invention.

Furthermore, during the heating step, the anisotropically shaped starting raw material powder may be preferably added with, in addition to the source of K, a source of Nb and/or a source of Ta.

In this case, the addition of such components enables the suppression of byproducts resulting from the heating step. This increases the content of the pentavalent metal acid alkali compound, represented by the general formula (4), in the anisotropically shaped powder.

Examples of the source Nb may preferably include a compound containing Nb such as, for instance, Nb₂O₅ or the like. Examples of the source Ta may preferably include a compound containing Ta such as, for instance, Ta₂O₅ or the like.

Further, the source of K, the source of Nb and the source of Ta may be preferably added to the anisotropically shaped starting raw material powder in a blending ratio such that an atomic ratio of a sum of an element Nb and an element Ta, contained in the sources, and an atomic ratio of an element K have a ratio of 1:1.

Such a blending ratio enables the formation of byproducts to be further suppressed. This enables a further increase in the content of the pentavalent metal acid alkali compound, represented by the general formula (4), in the anisotropically shaped powder.

### Fourth Aspect of Invention

Next, a manufacturing method of a fourth aspect of the present invention is described below in detail.

According to the fourth aspect of the present invention, the manufacturing method includes the acid-treating step and the heating step for manufacturing the anisotropically shaped powder, composed of a principal component including an isotropic perovskite-based pentavalent metal acid alkali compound represented by a general formula (6): (KₐNa₁₋ₐ)NbO₃ (wherein 0≦a≦0.8), which includes oriented grains with a specific crystal plane {100} of each oriented grain being oriented.

In the acid-treating step, an anisotropically shaped starting raw material powder is prepared in a composition of a bismuth-layer-like perovskite-based compound represented by a general formula (7): (Bi₂O₂)²⁺{Bi_{0.5}(K_{c}Na_{1-c})_{m-1.5}NbₘO₃ₘ₊₁}²⁻ (wherein “m” is an integer number greater than 2 and 0≦c≦0.8). Then, the anisotropically shaped starting raw material powder is acid treated to obtain an acid-treated substance.

In the general formula (7), if a value of “c” is out of the specified range mentioned above, there is a fear of a difficulty encountered in obtaining the anisotropically shaped powder in the target composition represented by the general formula (6).

In addition, if a value of “m” amounts in excess, there is another fear of non-anisotropically shaped perovskite fine particles appearing in addition to the formation of the anisotropically shaped powder of the bismuth-layer-like perovskite-based compound during the synthesizing step. Accordingly, the value of “m” may preferably lie in an integer number less than 15 in view of obtaining an improved yield ratio of the anisotropically shaped particles.

Further, the acid treatment may adopt a method of the starting raw material in the same acid as that used in the second aspect of the present invention while heating the same.

During the heating step, at least a source of K and/or source of Na are added to the acid-treated substance to provide a mixture, which in turn is heated in a flux including a principal component composed of NaCl and/or KCl.

Examples of the source of K and the source Na may preferably include the same compositions as those used in the second aspect of the present invention.

Further, the source of K and/or source of Na may be preferably added to the acid-treated substance at a ratio of 1 to 5 mol in a sum of the element K and the element Na contained in the source of K and/or source of Na per 1 mol of the bismuth-layer-like perovskite-based compound represented by the general formula (7).

If the sum of the element K and the element Na, contained in the source of K and/or the source of Na, is less than 1 mol, it becomes hard for a Na-defect and/or a K-defect in the acid-treated substance to be sufficiently substituted with K and/or Na. This results in a fear of an increase in the number of A-site defects in the pentavalent metal acid alkali compound represented by the general formula (6). Meanwhile, if the sum of the element K and the element Na is greater than 5 mol, the anisotropically shaped powder particles are likely to be fusion bonded to each other during the heating treatment in flux.

### Fifth Aspect of Invention

Next, a manufacturing method of a fifth aspect of the present invention is described below in detail.

According to the fifth aspect of the present invention, the manufacturing method includes the preparing step and the heating step, both mentioned above, for manufacturing an anisotropically shaped powder, composed of a principal component including an isotropic perovskite-based pentavalent metal acid alkali compound represented by a general formula (8): (K_{f}Na_{1-f})NbO₃ (wherein 0<f≦0.8), which includes oriented grains with a specific crystal plane {100} of each oriented grain being oriented.

In the general formula (8), “f” has the same criticality significance as that of “a” in the general formula (1) set forth above. In case of “f=0”, then, the manufacturing method of the fifth aspect of the present invention cannot be applied.

In the preparing step described above, an anisotropically shaped starting raw material powder is prepared in a principal component, including NaNbO₃, which includes oriented grains with a specific crystal plane {100} of each oriented grain being oriented.

During the heating step described above, further, at least a source of K is added to the anisotropically shaped starting raw material powder and the resulting mixture is heated in a flux including a principal component of KCl.

Examples of the source of K may preferably include the same component as that used in the second aspect of the present invention.

Furthermore, in the heating step, the anisotropically shaped starting raw material powder may be preferably added with, in addition to the source of K, a source of Nb.

In this case, the addition of such component enables the suppression of the formation of byproducts resulting from the heating step. In addition, this simply increases the content of the pentavalent metal acid alkali compound represented by the general formula (8) in the anisotropically shaped powder.

Examples of the source of Nb may preferably include a compound containing Nb such as, for instance, Nb₂O₅ or the like.

Further, the source of K and the source of Nb may be preferably added to the anisotropically shaped starting raw material powder in a blending ratio such that an atomic ratio of an element K and an atomic ratio of an element Nb, contained in the sources, have a ratio of 1:1.

In this case, such a blending ratio enables a further suppression of byproducts, thereby increasing the content of the pentavalent metal acid alkali compound represented by the general formula (8) in the anisotropically shaped powder.

### Sixth and Seventh Aspects of Invention

Next, manufacturing methods of sixth and seventh aspects of the present invention are described below in detail.

According to the sixth and seventh aspects of the present invention, each of the manufacturing methods includes the mixing step, the forming step and the sintering step, mentioned above, for manufacturing a crystal oriented ceramics, composed of a polycrystal with a main phase formed in an isotropic perovskite-based compound represented by the general formula (2): {Liₓ(K_{1-y}Na_{y})₁₋ₓ} (Nb_{1-z-w}Ta_{z}Sb_{w})O₃ (wherein 0≦x≦0.2, 0≦y≦1, 0≦z≦0.4, 0≦w≦0.2, and x+z+w>0), which includes crystal grains with a specific crystal plane {100} of each crystal grain constituting the polycrystal being oriented.

As used herein, the term “isotropic” refers to a phase in which with a perovskite-based structure ABO₃ expressed in terms of a pseudocubic-based lattice, relative ratios of axial lengths “a, “b” and “c” lie in a value ranging from 0.8 to 1.2 with axial angles α, β, γ laying in a value ranging from 80 to 100°.

In the general formula (2) mentioned above, furthermore, reference “x+z+w>0” represents that at least one element of Li, Ta and Sb may suffice to be included.

In the general formula (2) mentioned above, moreover, reference “y” represents a ratio of K to Na contained in the isotropic perovskite-based compound.

In the compound expressed by the general formula (2), at least one of K and Na may suffice to be included as an A-site element.

In the general formula (2) mentioned above, further, “y” may preferably lie in a range established by 0<y≦1.

In this case, the element Na becomes an essential ingredient for the compound expressed by the general formula (2). Therefore, this enables the crystal oriented ceramics to have a further improved piezoelectric g₃₁ constant.

In the general formula (2) mentioned above, further, reference “y” may preferably lie in a range expressed by 0≦y<1.

In this case, the element K becomes an essential ingredient for the compound expressed by the general formula (2). Therefore, this enables the crystal oriented ceramics to have a further improved characteristic such as the piezoelectric g₃₁ constant. Moreover, in this case, with an increase in the amount of K to be added, the crystal oriented ceramics can be sintered at a lower temperature. This results in a capability of manufacturing the crystal oriented ceramics in energy saving at low cost.

In the general formula (2) described above, further, reference “y” may further preferably lay in a range expressed by 0.05≦y≦0.75 and, more preferably, lay in a range expressed by 0.20≦y≦0.70. These conditions enable the crystal oriented ceramics to have further improved piezoelectric g₃₁ constants and electrical solution total numbers Kρ. Still more preferably, reference “y” may lie in a range expressed by 0.20≦y<0.70 and, even more preferably, lay in a range expressed by 0.35≦y≦0.65. Moreover, it is mostly preferable for such a range to lie in a value of 0.42≦y≦0.60.

As used herein, reference “x” represents the amount of Li for K and/or Na, forming the A-site element, to be substituted. If a part of K and/or Na is substituted with Li, various advantages are given with improved piezoelectric characteristic, an increase in Curie temperature and/or a promotion in densification.

In the general formula (2), moreover, reference “x” may preferably lie in a range expressed by 0<x≦0.2.

In this case, the element Li becomes an essential ingredient for the compound expressed in the general formula (2). This enables the crystal oriented ceramics to be further easily sintered during a manufacturing process while making it possible to provide further improved piezoelectric characteristic and a further increase in Curie temperature (Tc). This is because the element Li is rendered to be an essential ingredient within the range of “x” with the resultant reduction in a sintering temperature while rendering the element Li to play a role as a sintering aid with a capability of conducting the sintering step to obtain the crystal oriented ceramics with less number of pores.

If the value of “x” exceeds 0.2, degradations are likely to occur in piezoelectric characteristics (such as piezoelectric g₃₁ constant, electromechanical coupling coefficient kρ and piezoelectric g₃₂ constant, etc.).

Further, the value of “x” in the general formula (2) may lie in the relation as expressed as x=0.

In this case, the general formula (2) is rewritten as: (K_{1-y}Na_{y})(Nb_{1-z-w}Ta_{z}Sb_{w})O₃. Thus, when manufacturing the crystal oriented ceramics, the crystal oriented ceramics does not have a compound containing the lightest element Li such as, for instance, LiCO₃. This minimizes variation in characteristics of the crystal oriented ceramics resulting from the segregation of powder materials during the formation of the crystal oriented ceramics upon mixing a raw material. In this case, further, the crystal oriented ceramics can realize a relatively high dielectric constant and relatively large piezoelectric g₃₁ constant. In the general formula (2), the value of “x” may preferably lie in a range of 0≦x≦0.15 and, more preferably, lie in a range of 0≦x≦0.10.

Reference “z” represents the amount of Ta for the element Nb forming a B-site element to be substituted. If a part of Nb is substituted with Ta, then, an advantage appears with an improvement in piezoelectric characteristic or the like. In the general formula (2), a value of “z” exceeds 0.4, then, a drop occurs in Curie temperature. Thus, such a material is hard to be applied as a piezoelectric material for electrical appliances and motor vehicles.

In the general formula (2), a range of “z” may preferably lie in a relationship expressed as 0<z≦0.4.

In this case, Ta becomes an essential ingredient in the compound represented by the general formula (2). Therefore, in this case, a drop occurs in a sintering temperature and Ta plays a role as a sintering aid, enabling the crystal oriented ceramics to be manufactured with less number of pores.

Further, the value of “z” in the general formula (2) may lie in the relation as expressed as z=0.

In this case, the general formula (2) is rewritten as: {Liₓ(K_{1-y}Na_{y})₁₋ₓ} (Nb_{1-w}Sb_{w})O₃.

In this case, the compound expressed in the general formula (2) does not contain Ta. In this case, therefore, the compound expressed in the general formula (2) can be fabricated without using the expensive Ta component and have superior piezoelectric characteristic.

In the general formula (2) mentioned above, further, the value of “z” may preferably lie in a range expressed by 0≦z≦0.35 and, more preferably, in a range of 0≦z≦0.30.

As used herein, reference “w” represents the amount of Sb to be substituted for Nb forming the B-site element. If a part of Nb is substituted with Sb, an advantage results with improvement in piezoelectric characteristics.

If the value of “w” is greater than 0.2, then, degradations occur with drops in piezoelectric characteristics and/or Curie temperature.

Further, the value of “w” may be preferably lie in the relationship expressed as 0<w≦0.2.

In this case, Sb becomes an essential ingredient for the compound expressed in the general formula (2). Under such a condition, therefore, therefore, a drop occurs in a sintering temperature to provide improved sintering capability, making it possible to improve a stability of dielectric loss tan δ.

Furthermore, the value of “w” in the general formula (2) may lie in the relationship as expressed as w=0.

In this case, the general formula (2) is rewritten as: {Liₓ(K_{1-y}Na_{y})₁₋ₓ} (Nb_{1-z}Ta_{z})O₃.

In this case, further, the compound expressed in the general formula (2) does not contain Sb. Under such a relationship, therefore, the compound expressed in the general formula (2) does not contain Sb and exhibits a relatively high Curie temperature.

In the general formula (2) mentioned above, moreover, the value of “w” may preferably lie in a range expressed by 0≦w≦0.15 and, more preferably, in a range of 0≦w≦0.10.

In the mixing step, the anisotropically shaped powder and the reactive raw material, forming the isotropic perovskite-based compound expressed in the general formula (2) when reacted with the anisotropically shaped powder to, are mixed, thereby preparing a raw material mixture.

With the sixth aspect of the present invention, for the anisotropically shaped powder, use is made of the anisotropically shaped powder, obtained in the first aspect of the present invention, or the anisotropically shaped powder obtained in the manufacturing methods of the second to fifth aspects of the present invention.

Further, the seventh aspect of the present invention includes the step of acid treating an anisotropically shaped starting raw material powder composed of a bismuth-layer-like perovskite-based compound represented by a general formula (9): (Bi₂O₂)²⁺{Bi_{0.5}(K_{c}Na_{1-c})_{m-1.5}(Nb_{1-g}Ta_{g})ₘO₃ₘ₊₁}²⁻ (wherein “m” is an greater than 2, 0≦c≦0.8 and 0≦g≦0.4). This results in an acid-treated substance, which is used as the anisotropically shaped powder.

In the general formula (9), if a value of “c” is greater than 0.8, then, a drop occurs in a melting point of the anisotropically shaped powder. When manufacturing a crystal oriented ceramics using such an anisotropically shaped powder, there is likelihood of a fear with a difficulty in obtaining the anisotropically shaped powder with a high degree of orientation.

Meanwhile, if a value of “g” is greater than 0.4, then, a drop occurs in a Curie temperature of the resulting crystal oriented ceramics manufactured using such an anisotropically shaped powder. This causes a difficulty to occur in application of such an anisotropically shaped powder to a piezoelectric material for electric appliances and automotive use.

Further, if “m” increases in excess, there is a risk of the occurrence of non-anisotropically shaped perovskite fine particles besides an anisotropically shaped powder of a bismuth-layer-like perovskite-based compound during a synthesizing step. Accordingly, “m” may preferably take an integer number less than with a view to having improved yield ratio of the anisotropically shaped powder.

Next, in the sixth and seventh aspects of the present invention, the reactive raw material may preferably have a particle diameter less than one-third of that of the anisotropically shaped powder.

If the particle diameter of the reactive raw material exceeds one-third of a particle diameter of the anisotropically shaped powder, it is likely that a difficulty arising in the step of forming the raw material mixture so as to allow specific crystal planes {100} of the anisotropically shaped powder to be oriented in the substantially same direction. More preferably, the reactive raw material may have a particle diameter less than one-fourth of the particle diameter of the anisotropically shaped powder and, still more preferably, a particle diameter less than one-fifth of the particle diameter of the anisotropically shaped powder.

The comparison in particle diameter between the reactive raw material and the anisotropically shaped powder can be achieved upon comparing an average particle diameter of the reactive raw material to an average particle diameter of the anisotropically shaped powder. In addition, any of the particle diameters of both the reactive raw material and the anisotropically shaped powder refers to a diameter of each particle with the longest size.

The reactive raw material may have a composition that can be determined depending on a composition of the anisotropically shaped powder and a composition of the isotropic perovskite-based compound to be manufactured in a composition expressed by the general formula (2). Moreover, examples of the reactive raw material may preferably include, for instance, an oxidized powder, a composite oxide powder, a hydroxide powder or salts such as carbonates, nitrates and oxalates, or alkoxides, etc.

The reactive raw material may preferably include an non-anisotropically shaped powder composed of an isotropic perovskite-based compound represented by a general formula (10): {Liₓ(K_{1-y}Na_{y})₁₋ₓ} (Nb_{1-z-w}Ta_{z}Sb_{w})O₃ (wherein 0≦x≦1, 0≦y≦1, 0≦z≦1 and 0≦w≦1).

In this case, a crystal oriented ceramics can be easily manufactured in a structure with high density and high degree of orientation.

Examples of the reactive raw material may preferably include those which react with the anisotropically shaped powder during a sintering process to form the isotropic perovskite-based compound in a target composition expressed by the general formula (2).

Further, the reactive raw material may preferably include those that react with the anisotropically shaped powder to form only the isotropic perovskite-based compound in the target composition or those that react with the anisotropically shaped powder to form both the isotropic perovskite-based compound in the target composition and a surplus component.

In a case where the anisotropically shaped powder and the reactive raw material react with each other to form the surplus component, the surplus component may be preferably of the type that can be thermally or chemically removed in an easy fashion.

In the mixing step set forth above, the anisotropically shaped powder and the reactive raw material powder, reacting with the anisotropically shaped powder to provide the isotropic perovskite-based compound represented by the general formula (2), are mixed to each other, thereby preparing a raw material mixture.

In the mixing step, the anisotropically shaped powder and the reactive raw material powder may be mixed to each other under a dry state or a wet state added with an appropriate dispersant such as water, alcohol or the like. During such mixing, further, at least one kind of compounds selected from a binder, a plasticizer and a dispersant, etc., may be added depending on needs.

In the forming step set forth above, the raw material mixture is formed into a compact body such that the crystal planes {100} of the anisotropically shaped powder are oriented in the substantially same direction.

Examples of the forming step may preferably include those which can align the crystal planes of the anisotropically shaped powder in an oriented state. In particular, for the step of forming the raw material mixture in the compact body so as to allow the anisotropically shaped powder to be oriented on the plane, appropriate processes can be employed including a doctor blade method, a press forming method and a press rolling method, etc.

In the firing step, the compact body is heated causing the anisotropically shaped powder and the raw material powder to react with each other in a sintered state, thereby obtaining the crystal oriented ceramics.

During the firing step, as the compact body is heated, the sintering proceeds, resulting in the crystal oriented ceramics composed of a polycrystal substance with a main phase in the isotropic perovskite-based compound. When this takes place, reacting the anisotropically shaped powder and the raw material powder enables the isotropic perovskite-based compound to be formed in the composition represented by the general formula (2). Further, during the firing step, a surplus component is also simultaneously produced depending on compositions of the anisotropically shaped powder and the raw material powder.

The heating temperatures for the firing step may be preferably set to an appropriate temperature selected depending on the compositions of the anisotropically shaped powder to be used, the reactive raw material and the crystal oriented ceramics to be manufactured. This allows the reaction and/or the sintering to be efficiently progressed to form a reacted product in a target composition. In particular, the heating temperature may preferably lie in a value ranging from, for instance, 900° C. to 1300° C.

Next, various Examples of the present invention will be described below.

### EXAMPLE 1

In Example 1, an anisotropically shaped powder was fabricated in a principal component of an isotropic perovskite-based pentavalent metal acid alkali compound, represented by the general formula (1): (KₐNa₁₋ₐ)(Nb_{1-b}Ta_{b})O₃ (wherein 0≦a≦0.8 and 0.02≦b≦0.4), which included oriented grains with a specific crystal plane {100} of each oriented grain being oriented. In this Example, the anisotropically shaped powder was manufactured in a compound with a=0 and b=0.07 in the general formula (1), that is, in a principal component of Na(Nb_{0.93}Ta_{0.07})O₃.

More particularly, first, powders of Bi₂O₃, NaHCO₃, Nb₂O₅ and Ta₂O₅ were weighed in a stoichiometric ratio to form a composition of Bi_{2.5}Na_{3.5}(Nb_{0.93}Ta_{0.07})₅O₁₈, upon which the powders were mixed in a wet process. Subsequently, 80 wt. parts of NaCl was added as a flux to 100 wt. parts of the resulting mixture, upon which the resulting substance was mixed in a dry state for 1 hour.

Then, the resulting mixture was placed in a platinum crucible and heated at a temperature of 1100° C. for 2 hours, thereby synthesizing a compound in a composition of Bi_{2.5}Na_{3.5}(Nb_{0.93}Ta_{0.07})₅O₁₈. The resulting mixture was heated on a first stage from a room temperature up to a temperature of 850° C. at a temperature rising rate of 150° C./h and further heated on a second stage from the temperature of 850° C. up to a temperature of 1100° C. at a temperature rising rate of 100° C./h. Subsequently, the resulting reacted substance was cooled to the room temperature at a temperature drop rate of 150° C./h. Then, the resulting reacted substance was subjected to hot-water washing to remove the flux, thereby obtaining a powder of Bi_{2.5}Na_{3.5}(Nb_{0.93}Ta_{0.07})₅O₁₈. The resulting powder of Bi_{2.5}Na_{3.5}(Nb_{0.93}Ta_{0.07})₅O₁₈ appeared in plate-like particles having planes {100} placed in an oriented plane (in a maximal plane).

Subsequently, the powder of Bi_{2.5}Na_{3.5}(Nb_{0.93}Ta_{0.07})₅O₁₈ was pulverized using a jet mill. The powder of Bi_{2.5}Na_{3.5}(Nb_{0.93}Ta_{0.07})₅O₁₈ resulting from the pulverization had an average particle diameter of approximately 12 μm with an aspect ratio of approximately 10 to 20 μm.

Then, 2 mol of the powder of NaHCO₃ was added to 1 mol of Bi_{2.5}Na_{3.5}(Nb_{0.93}Ta_{0.07})₅O₁₈ powder and mixed therewith in a dry state. 80 wt. parts of NaCl was added to 100 wt. parts of the resulting mixture and mixed therewith in the dry state for 1 hour.

Next, the resulting mixture was heated in the platinum crucible at a temperature of 950° C. for 8 hours, thereby synthesizing a compound in a composition of Na(Nb_{0.93}Ta_{0.07})O₃. The resulting compound was heated on a first stage from a room temperature up to a temperature of 700° C. at a temperature rising rate of 200° C./h and further heated on a second stage from the temperature of 700° C. up to a temperature of 950° C. at a temperature rising rate of 50° C./h. Subsequently, the resulting compound was cooled to the room temperature at a temperature drop rate of 150° C./h, thereby obtaining the reacted substance.

The resulting reacted substance contained Bi₂O₃ besides the composition of Na(Nb_{0.93}Ta_{0.07})O₃. Therefore, the reacted substance was subjected to hot water washing to remove the flux, upon which Bi₂O₃ was removed. That is, first, the reacted substance subsequent to the removal of flux, was stirred in 2.5N HNO₃ for 4 hours, thereby dissolving Bi₂O₃ resulting as a surplus residue. Then, this solution was filtered to separate Na(Nb_{0.93}Ta_{0.07})O₃ powder particles and washed with ion-exchanged water at a temperature of 80° C.

In such away, an anisotropically shaped powder was obtained including Na(Nb_{0.93}Ta_{0.07})O₃ powder. This anisotropically shaped powder took plate-like powder particles with excellent surface smoothing capability and having a pseudocubic {100} plane aligned on a maximal plane (oriented plane) with an average particle diameter of 12 μm and an aspect ratio of approximately 10 to 20 μm.

FIG. 1 shows a scanning electron microscope image of the anisotropically shaped powder obtained in Example 1.

Then, a crystal oriented ceramics was manufactured using the resulting anisotropically shaped powder.

In this Example, the mixing step, the forming step and the firing step were implemented to manufacture the crystal oriented ceramics in a composition of a polycrystal with a main phase formed in an isotropic perovskite-based compound in a composition of (Li_{0.06}K_{0.423}Na_{0.517})(Nb_{0.835}Ta_{0.1}Sb_{0.065})O₃ with a crystal plane {100} of each crystal grain, constituting the polycrystal, being oriented.

In the mixing step, the anisotropically shaped powder and the reactive raw material, reacting with the anisotropically shaped powder to provide the isotropic perovskite-based compound, were mixed to each other, thereby preparing a raw material mixture.

In the forming step, further, the raw material mixture was shaped to form a compact body in a structure with crystal planes {100} of the anisotropically shaped powder being oriented in the substantially same direction.

In the firing step, the compact body was heated causing the anisotropically shaped powder and the reactive raw material to react with each other in sintering, thereby obtaining the crystal oriented ceramics.

More particularly, the reactive raw material was initially prepared in a manner described below.

That is, first, commercially available powders of NaHCO₃, KHCO₃, Li₂CO₃, Nb₂O₅, Ta₂O₅ and NaSbO₃ were weighed in a blend so as to provide a composition wherein 0.05 mol of Na(Nb_{0.93}Ta_{0.07})O₃ powder, used as the anisotropically shaped powder, was subtracted from 1 mol of stoichiometric composition of (Li_{0.06}K_{0.423}Na_{0.517})(Nb_{0.835}Ta_{0.1}Sb_{0.065})O₃ forming a target composition upon sintering the anisotropically shaped powder and the reactive raw material. This blend was then mixed in a ZrO₂ bowl with medium, such as an organic solvent, in a wet state for 20 hours to obtain a blend mixture. Thereafter, the blend mixture was provisionally fired at a temperature of 750° C. for 5 hours to obtain a provisionally fired substance. Then, the provisionally fired substance was pulverized in medium such as the organic solvent with ZrO₂ balls for 20 hours, thereby obtaining a provisionally fired powder substance as a reactive raw material with an average particle diameter of approximately 0.5 μm.

The anisotropically shaped powder and the reactive raw material, prepared in such a way mentioned above, were weighed in stoichiometric ratio so as to provide a powder mixture forming a compound in a composition of (Li_{0.06}K_{0.423}Na_{0.517})(Nb_{0.835}Ta_{0.1}Sb_{0.065})O₃ when sintered. More particularly, the anisotropically shaped powder and the reactive raw material were weighed in a molar ratio of 0.05:0.95 (anisotropically shaped powder:reactive raw material) to provide a blend. After the weighing step having been finished, the blend was mixed in medium composed of an organic solvent in the wet state with ZrO₂ balls for 20 hours, thereby obtaining slurry. Thereafter, a binder such as polyvinyl butyral and a plasticizer such as dibutyl phthalate were added to the slurry. After having been further mixed, 8.0 g of binder and 4.0 g of plasticizer were added to 100 g of (Li_{0.06}K_{0.423}Na_{0.517})(Nb_{0.835}Ta_{0.1}Sb_{0.065})O₃ synthesized from the starting raw material. In such a way, a slurry-like raw material mixture was obtained.

Next, the mixed slurry-like raw material mixture was tape-cast using a doctor-blading apparatus, thereby obtaining green strips each with a thickness of 100 μm. The resulting green strips were stacked and pressure bonded to each other, thereby obtaining a compact body in a stacked state with a thickness of 1.2 mm. With the green strips shaped by the doctor-blading apparatus, shearing stresses acted on the anisotropically shaped powder particles. This caused the anisotropically shaped powder particles to be oriented in the substantially same direction within the compact body.

Next, the compact body was heated in atmosphere at a temperature of 400° C. for degreasing. The compact body, subjected to the degreasing step, was then placed on a Pt plate in a magnesia bawl to be heated and fired in atmosphere at a temperature of 1120° C. for 5 hours. Thereafter, the compact body was cooled, thereby obtaining a crystal oriented ceramics. This ceramics was treated as a specimen E1. In this Example, the heating and cooling were carried out on a firing pattern at a temperature rising rate of 200° C./h and a cooling rate of 200° C./h. The firing step in this Example exhibited a simplified trapezoidal firing pattern when plotted a time on the abscissa axis and a temperature on the ordinate axis.

Then, a bulk density of the crystal oriented ceramics of the specimen E1 was measured.

More particularly, first, a weight (dry weight) of the crystal oriented ceramics in a dry state was measured. Subsequently, the crystal oriented ceramics was dipped in water to cause water to penetrate pour portions, after which the weight (hydrous weight) of the crystal oriented ceramics was measured. Then, a volume of opening pours present in the crystal oriented ceramics was calculated based on a difference between the hydrous weight and the dry weight. Moreover, a volume of the crystal oriented ceramics with the opening pours being excepted was measured on a principle of Archimedes. Next, dividing the dry weight of the crystal oriented ceramics by an entire volume (including a sum of the volume of the opening pores and the volume of the portion excepting the opening pores) allowed the calculation of the bulk density of the crystal oriented ceramics.

Further, an internal orientation degree of the crystal oriented ceramics of the specimen E1 was measured.

More particularly, first, a surface of the crystal oriented ceramics was grounded on a plane parallel to a surface of the tape in a depth of 150 μm from the surface of the crystal oriented ceramics. Then, an average orientation factor F (100) of a plane {100} of the resulting grounded surface according to a Lotgering method was calculated using the formula (1). This result was indicated on Table 1 that will be described later.

### EXAMPLE 2

In this Example 2, the manufacturing method was carried out to manufacture a compound with a=0.56 and b=0.07 in the general formula (1): (KₐNa₁₋ₐ)(Nb_{1-b}Ta_{b})O₃ (wherein 0≦a≦0.8 and 0.02≦b≦0.4). That is, an anisotropically shaped powder was manufactured having a principal component of (K_{0.56}Na0.44)(Nb_{0.93}Ta_{0.07})O₃ and including oriented grains with a specific crystal plane {100} of each oriented grain being oriented.

In this Example, an acid-treating step and a heating step were carried out to manufacture the anisotropically shaped powder.

In the acid-treating step, an anisotropically shaped starting raw material powder was prepared in a composition of a bismuth-layer-like perovskite-based compound represented by the general formula (3): (Bi₂O₂)²⁺ {Bi_{0.5}(K_{c}Na_{1-c})_{m-1.5}(Nb_{1-b}Ta_{b})ₘO₃ₘ₊₁}²⁻ (wherein “m” is an integer number greater than 2, 0≦c≦0.8 and 0.02≦b≦0.4). The starting raw material powder was acid treated, thereby obtaining an acid-treated substance. In this Example, for the anisotropically shaped starting raw material powder of the bismuth-layer-like perovskite-based compound, use was made of a compound with m=5, c=0 and b=0.07 in the general formula (3), that is, an anisotropically shaped starting raw material powder in a composition of Bi_{2.5}Na_{3.5}(Nb_{0.93}Ta_{0.07})₅O₁₈.

In the heating step, furthermore, at least a source of K and/or a source of Na were added to the acid-treated substance. The resulting mixture was heated in a flux including a principal component composed of NaCl and/or KCl. This allowed the anisotropically shaped powder to be manufactured in a principal component of (K_{0.56}Na_{0.44})(Nb_{0.93}Ta_{0.07})O₃ and including oriented grains with a specific crystal plane {100} of each oriented grain being oriented.

Now, the method of manufacturing the anisotropically shaped powder of this Example will be described below in detail.

First, for the anisotropically shaped starting raw material powder composed of Bi_{2.5}Na_{3.5}(Nb_{0.93}Ta_{0.07})₅O₁₈, use was made of the powder of Bi_{2.5}Na_{3.5}(Nb_{0.93}Ta_{0.07})₅O₁₈ prepared in Example 1.

30 ml of 6N HCl was added to 1 g of the starting raw material powder and the resulting mixture was stirred at a temperature of 60° C. for 24 hours. Thereafter, the resulting mixture was filtered in suction, thereby obtaining an acid-treated substance in the form of a powder of Bi_{2.5}Na_{3.5}(Nb_{0.93}Ta_{0.07})₅O₁₈.

Subsequently, a powder of KHCO₃ was added as a source of K to the acid-treated substance. The powder of KHCO₃ was added to the acid-treated substance in a molar ratio of 2 mol based on 1 mol of the acid-treated substance. Then, 80 wt. parts of KCl serving as a flux was added to 100 wt. parts of a mixture between the acid-treated substance and the source of K and stirred in a dry state for 1 hour. Thereafter, the resulting mixture was heated in the platinum crucible at a temperature of 1000° C. for 8 hours. The heating was conducted on a first stage from a room temperature up to a temperature of 700° C. with a first temperature rising rate of 200° C./h and further heated on a second stage from the temperature of 700° C. up to a temperature of 1000° C. with a second temperature rising rate of 50° C./h. Subsequently, the resulting mixture was cooled to a room temperature at a temperature drop rate of 150° C./h, thereby obtaining a reacted substance.

The resulting reacted substance was subjected to hot water washing to remove the flux, thereby obtaining an anisotropically shaped powder.

A crystal phase of the anisotropically shaped powder was analyzed and identified using an energy dispersive X-ray analyzer (EDX) and an X-ray diffractometry (XRD). As a result, it was turned out that the anisotropically shaped powder was composed of a perovskite compound including a principal component of a powder of (K_{0.56}Na_{0.44})(Nb_{0.93}Ta_{0.07})O₃. This anisotropically shaped powder was a plate-like powder, having excellent surface smoothing capability with a pseudocubic plane {100} placed in a maximal plane (oriented plane), which had an average particle diameter of approximately 12 μm and an aspect ratio of approximately 10 to 20 μm.

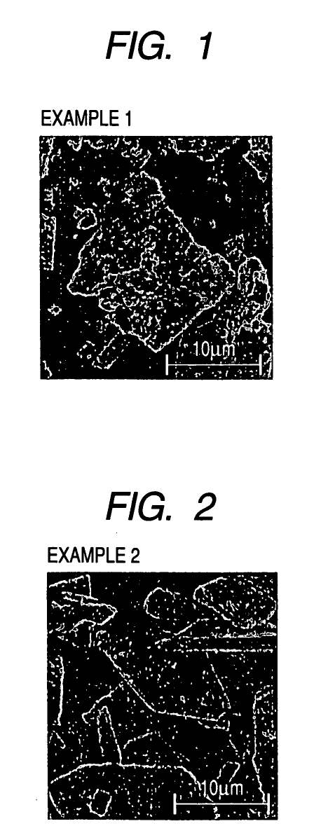

FIG. 2 shows a scanning electron microscope image of the anisotropically shaped powder prepared in Example 2.

Next, the manufacturing method was carried out using the anisotropically shaped powder of (K_{0.56}Na_{0.44})(Nb_{0.93}Ta_{0.07})O₃ prepared in this Example for manufacturing a crystal oriented ceramics in the same composition as that of Example 1. That is, the crystal oriented ceramics of this Example was composed of a polycrystal substance with a main phase formed in an isotropic perovskite-based compound of (Li_{0.06}K_{0.423}Na_{0.517})(Nb_{0.835}Ta_{0.1}Sb_{0.065})O₃ like that of Example 1 with planes {100} of crystal grains forming the polycrystal substance being oriented.

More particularly, first, powders of NaNbO₃, KNbO₃, LiTaO₃, KTaO₃ and NaSbO₃ each with an average particle diameter of approximately 0.5 μm were weighed in a blend so as to provide a composition wherein 0.05 mol of a powder of (K_{0.56}Na_{0.44})(Nb_{0.93}Ta_{0.07})O₃, used as the anisotropically shaped powder, is subtracted from 1 mol of stoichiometric composition of (Li_{0.06}K_{0.423}Na_{0.517})(Nb_{0.835}Ta_{0.1}Sb_{0.065})O₃ forming a target composition upon sintering the anisotropically shaped powder and the reactive raw material. This blend was then mixed in medium, such as an organic solvent, with ZrO₂ balls for 4 hours, thereby obtaining a mixture powder as a reactive material with an average particle diameter of approximately 0.5 μm.

The anisotropically shaped powder and the reactive raw material, prepared in such a way mentioned above, were weighed in stoichiometric ratio so as to provide a composition of (Li_{0.06}K_{0.423}Na_{0.517})(Nb_{0.835}Ta_{0.1}Sb_{0.065})O₃ when sintered. More particularly, the anisotropically shaped powder and the reactive raw material were weighed in a molar ratio of 0.05:0.95 (anisotropically shaped powder:reactive raw material) to provide a blend. The blend was mixed in medium to prepare a slurry-like raw material mixture in the same way as that of Example 1. This slurry-like raw material mixture was shaped into a compact body in the same manner as that of Example 1, after which the compact body was subjected to a degreasing step.

Next, the compact body was placed on a Pt plate in a magnesia bawl to be heated and fired in atmosphere at a temperature of 1160° C. for 5 hours. Thereafter, the compact body was cooled to obtain a crystal oriented ceramics. This ceramics was treated as a specimen E2. In addition, the heating and cooling steps were carried out on the same firing pattern as that adopted in Example 1 with the temperature rising rate of 200° C./h and the cooling rate of 200° C./h.

Subsequently, a bulk density and orientation degree were analyzed on the crystal oriented ceramics of the specimen E2, prepared in this Example, in the same manner as that implemented in Example 1. The results are indicated on Table 1 described below.

### EXAMPLE 3

In this Example 3, the manufacturing method was carried out to manufacture a compound with d=0.3 and b=0.11 in the general formula (4): (K_{d}Na_{-d})(Nb_{1-b}Ta_{b})O₃ (wherein 0<d≦0.8 and 0.02≦b≦0.4). That is, an anisotropically shaped powder was manufactured having a principal component of (K_{0.3}Na_{0.7})(Nb_{0.89}Ta_{0.11})O₃ and including oriented grains with a specific crystal plane {100} of each oriented grain being oriented.

In this Example, a preparing step and a heating step were carried out to manufacture the anisotropically shaped powder.

In the preparing step, an anisotropically shaped starting raw material powder was prepared in a principal component of a pentavalent metal acid alkali compound of an isotropic perovskite-based structure, represented by the general formula (5): Na(Nb₁₋ₑTaₑ)O₃ (wherein 0.02≦e≦0.4), which included oriented grains with a specific crystal plane {100} of each oriented grain being oriented.

In this Example 3, for the anisotropically shaped starting raw material powder, use was made of a compound with e=0.11 in the general formula (5), that is, an anisotropically shaped starting raw material powder in a composition of Na(Nb_{0.89}Ta_{0.11})O₃.

In the heating step, further, at least the source of K was added to the anisotropically shaped starting raw material powder. The resulting mixture was heated in a flux including the principal component composed of KCl. This resulted in an anisotropically shaped powder in a principal component of (K_{0.56}Na_{0.44})(Nb_{0.93}Ta_{0.07})O₃ and including oriented grains with a specific crystal plane {100} of each oriented grain being oriented. Also, in the heating step of this Example, besides the source of K, a source of Nb and a source of Ta were added to the anisotropically shaped starting raw material powder, after which the resulting mixture was heated.

Now, the method of manufacturing the anisotropically shaped powder of this Example will be described below in detail.

First, powders of Bi₂O₃, NaHCO₃, Nb₂O₅ and Ta₂O₅ were weighed in a stoichiometric ratio forming a compound in a general formula expressed as Bi_{2.5}Na_{3.5}(Nb_{0.89}Ta_{0.11})₅O₁₈, upon which these substances were mixed in a wet process. Subsequently, 80 wt. parts of NaCl was added as a flux to 100 wt. parts of the resulting mixture, upon which the resulting substance was mixed in a dry state for 1 hour.

Then, like the steps conducted in Example 1, the resulting mixture was heated in a platinum crucible at a temperature of 1100° C. for 2 hours. Thereafter, the resulting mixture was cooled and subjected to hot-water washing to remove the flux, thereby obtaining a powder of Bi_{2.5}Na_{3.5}(Nb_{0.89}Ta_{0.11})₅O₁₈. The powder of Bi_{2.5}Na_{3.5}(Nb_{0.89}Ta_{0.11})₅O₁₈ was pulverized using a jet mill, thereby obtaining a powder of Bi_{2.5}Na_{3.5}(Nb_{0.89}Ta_{0.11})₅O₁₈ with an average particle diameter of approximately 12 μm and an aspect ratio of approximately 10 to 20 μm.

Like Example 1, next, 2 mol of NaHCO₃ powder was added to 1 mol of Bi_{2.5}Na_{3.5}(Nb_{0.89}Ta_{0.11})₅O₁₈ powder and mixed therewith in a dry state. Then, 80 wt. parts of NaCl was added as a flux to 100 wt. parts of the resulting mixture and mixed therewith in a dry state for 1 hour. Like Example 1, further, the resulting mixture was heated in a platinum crucible at a temperature of 950° C. for 8 hours, after which the resulting mixture was cooled to obtain a reacted substance. The reacted substance contained a compound of Bi₂O₃ besides Na(Nb_{0.89}Ta_{0.11})O₃. Therefore, like Example 1, the reacted substance was subjected to hot water washing to remove the flux, after which Bi₂O₃ was removed. In such away, an anisotropically shaped starting raw material powder was obtained including a powder of Na(Nb_{0.89}Ta_{0.11})O₃. This anisotropically shaped powder took plate-like powder particles having a pseudocubic {100} plane on a maximal plane (oriented plane) with an average particle diameter of 12 μm and an aspect ratio of approximately 10 to 20 μm.

Thereafter, powders of KHCO₃, Nb₂O₅ and Ta₂O₅ were added as a source of K, a source of Nb and a source of Ta, respectively, to the anisotropically shaped starting raw material powder to provide a blend, which was mixed in a dry state. During such blending, the source of K, the source of Nb and the source of Ta were blended in an atomic ratio of K:Nb:Ta=1:0.89:0.11 and an atomic ratio of 0.55:0.45 for Na in the anisotropically shaped starting raw material powder of (Nb_{0.89}Ta_{0.11})O₃ and K in the source of K. Then, 80 wt. parts of KCl was added as a flux to 100 wt. parts of the resulting mixture and mixed in a dry state for 1 hour.

Subsequently, the resulting mixture was heated in a platinum crucible at a temperature of 1050° C. for 12 hours, thereby synthesizing a compound of (K_{0.3}Na_{0.7})(Nb_{0.89}Ta_{0.11})O₃. The heating was conducted on a first stage from a room temperature up to a temperature of 700° C. at a temperature rising rate of 200° C./h and further heated on a second stage from the temperature of 700° C. up to a temperature of 1050° C. at a temperature rising rate of 50° C./h. Thereafter, the resulting mixture was cooled to the room temperature at a temperature drop rate of 150° C./h, thereby obtaining a reacted substance. Subsequently, the reacted substance was subjected to hot water washing to remove the flux.

The reacted substance included a plate-like powder and a fine powder. The reacted substance (mixed powder) was subjected to a componential analysis using the energy dispersive X-ray analyzer (EDX) and a crystal phase of the anisotropically shaped powder was identified using the X-ray diffractometry (XRD) like the analyses conducted in Example 2. As a result, it was turned out that the plate-like powder was a perovskite compound including a principal component of a (K_{0.3}Na_{0.7})(Nb_{0.89}Ta_{0.11})O₃ powder and the fine powder was a perovskite compound including a principal component of a (K_{0.68}Na_{0.32})(Nb_{0.89}Ta_{0.11})O₃ powder.

Then, the fine powder was removed from the mixed powder by air separation, thereby obtaining an anisotropically shaped powder composed of the plate-like powder in a principal composition of (K_{0.3}Na_{0.7})(Nb_{0.89}Ta_{0.11})O₃. The anisotropically shaped powder was a plate-like powder with excellent surface smoothing capability having a pseudocubic plane {100} placed in a maximal plane (oriented plane) with an average particle diameter of approximately 12 μm and an aspect ratio of approximately 10 to 20 μm.

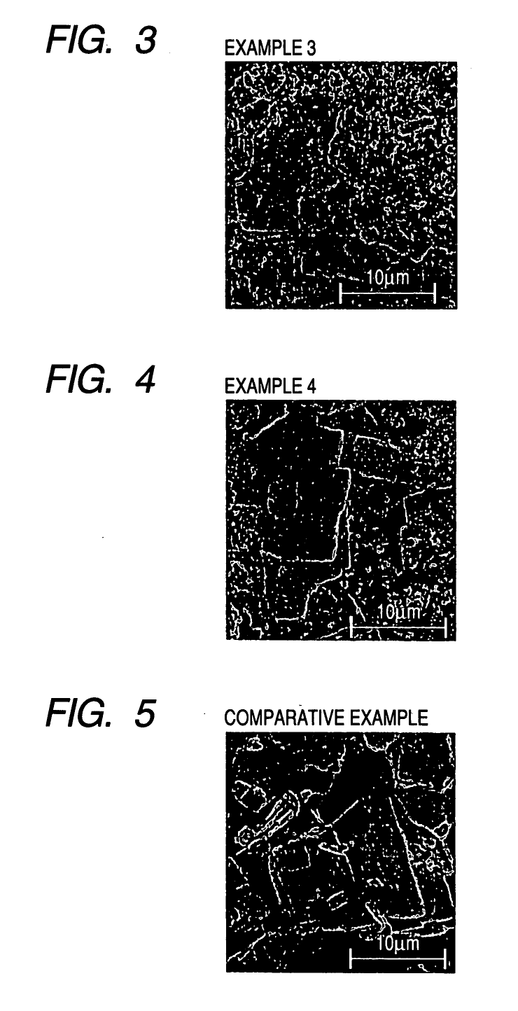

FIG. 3 shows a scanning electron microscope (SEM) image showing the anisotropically shaped powder prepared in this Example.

Next, a crystal oriented ceramics was manufactured in a manner similar to that of Example 1 using the anisotropically shaped powder of (K_{0.3}Na_{0.7})(Nb_{0.89}Ta_{0.11})O₃ prepared in this Example. That is, the crystal oriented ceramics of this Example was composed of a polycrystal substance with a main phase formed in an isotropic perovskite-based compound of (Li_{0.06}K_{0.423}Na_{0.517})(Nb_{0.835}Ta_{0.1}Sb_{0.065})O₃ like that of Example 1 with a plane {100} of each crystal grain constituting the polycrystal substance being oriented.

More particularly, first, commercially available powders of NaHCO₃, KHCO₃, Li₂CO₃, Nb₂O₅, Ta₂O₅ and NaSbO₃ were weighed in a blend to form a composition wherein 0.05 mol of (K_{0.3}Na_{0.7})(Nb_{0.89}Ta_{0.11})O₃ powder is subtracted from 1 mol of stoichiometric composition of (Li_{0.06}K_{0.423}Na_{0.517})(Nb_{0.835}Ta_{0.1}Sb_{0.065})O₃ forming a target composition upon sintering the anisotropically shaped powder and the reactive raw material. This blend was then mixed in medium, such as an organic solvent, in a wet state like the step in Example 1. The resulting mixture was provisionally fired, after which the resulting mixture was pulverized in a wet state, thereby obtaining a provisionally fired substance (reactive raw material) with an average particle diameter of approximately 0.5 μm.

The reactive raw material and the anisotropically shaped powder of (K_{0.3}Na_{0.7})(Nb_{0.89}Ta_{0.11})O₃ were weighed in stoichiometric ratio so as to provide a mixture forming a compound in a composition of (Li_{0.06}K_{0.423}Na_{0.517})(Nb_{0.835}Ta_{0.1}Sb_{0.065})O₃ when sintered. More particularly, the anisotropically shaped powder and the reactive raw material were weighed in a molar ratio of 0.05:0.95 (anisotropically shaped powder:reactive raw material) to provide a blend. Then, the blend was mixed in medium to prepare a slurry-like raw material mixture in the same way as that of Example 1. This slurry-like raw material mixture was shaped into a compact body in the same manner as that of Example 1, after which the compact body was subjected to the degreasing step.

Next, the compact body was fired in the same manner as that of Example 1, thereby obtaining a crystal oriented ceramics. This ceramics was treated as a specimen E3. In addition, the heating and cooling steps were carried out on the same firing pattern as that of Example 1 with the temperature rising rate of 200° C./h and the cooling rate of 200° C./h.

A bulk density and orientation degree of the crystal oriented ceramics of the specimen E3, manufactured in this Example, were measured in the same way as that of Example 1. The measured results were indicated in Table 1 described below.

### EXAMPLE 4

In this Example, the manufacturing method was carried out to manufacture a compound with a=0.65 and b=0.1 in the general formula (1): (KₐNa₁₋ₐ)(Nb_{1-b}Ta_{b})O₃ (wherein 0≦a≦0.8 and 0.02≦b≦0.4), that is, an anisotropically shaped powder having a principal component of (K_{0.65}Na_{0.35})(Nb_{0.9}Ta_{0.1})O₃ and including oriented grains with a specific crystal plane {100} of each oriented grain being oriented.

In this Example, like Example 2, the acid-treating step and the heating step were carried out to manufacture the anisotropically shaped powder of Na(Nb_{0.9}Ta_{0.1})O₃. The preparing step and the heating step were executed in the same manner as those of Example 3 using the Na(Nb_{0.9}Ta_{0.1})O₃ powder used as the anisotropically shaped raw material, thereby obtaining an anisotropically shaped powder in a principal component of (K_{0.65}Na_{0.35})(Nb_{0.9}Ta_{0.1})O₃ including oriented grains with a specific crystal plane {100} of each oriented grain being oriented.

First, a starting raw material powder was prepared in a composition of Bi_{2.5}Na_{3.5}(Nb_{0.9}Ta_{0.1})₅O₁₈. More particularly, powders of Bi₂O₃, NaHCO₃, Nb₂O₅ and Ta₂O₅ were weighed in a blend at a stoichiometric ratio giving a general formula expressed as Bi_{2.5}Na_{3.5}(Nb_{0.9}Ta_{0.9})₅O₁₈, upon which the blend was mixed in a wet process. Subsequently, 80 wt. parts of NaCl was added as a flux to 100 wt. parts of the resulting mixture, upon which the resulting substance was mixed in a dry state for 1 hour.

Then, like Example 1, the resulting mixture was heated in the platinum crucible at a temperature of 1100° C. for 2 hours. Thereafter, the resulting reacted substance was cooled and subjected to hot water washing to remove the flux, thereby obtaining a powder of Bi_{2.5}Na_{3.5}(Nb_{0.9}Ta_{0.1})₅O₁₈. This starting raw material powder of Bi_{2.5}Na_{3.5}(Nb_{0.9}Ta_{0.1})₅O₁₈ was a plate-like powder with a plane {001 } placed on an oriented plane (maximal plane).

Next, the starting raw material powder of Bi_{2.5}Na_{3.5}(Nb_{0.9}Ta_{0.1})₅O₁₈ was pulverized using the jet mill. The resulting starting raw material powder had an average particle diameter of approximately 12 μm and an aspect ratio of approximately 10 to 20 μm.

Subsequently, 30 ml of 6N HCl was added to 1 g of starting raw material powder in a beaker and the resulting mixture was stirred at a temperature of 60° C. for 24 hours. Thereafter, the resulting mixture was filtered by the suctioning, thereby obtaining an acid-treated substance in a powder of Bi_{2.5}Na_{3.5}(Nb_{0.9}Ta_{0.1})₅O₁₈.

Then, the powder of NaHCO₃ was added as a source of Na to the acid-treated substance and the resulting substance was mixed in a dry state. During such treatment, the powder of NaHCO₃ was added at a ratio of 2.8 mol to 1 mol of Bi_{2.5}Na_{3.5}(Nb_{0.9}Ta_{0.1})₅O₁₈. Thereafter, 80 wt. parts of NaCl was added as a flux to 100 wt. parts of the resulting mixture, composed of a mixture between the acid-treated substance and the source of Na, and mixed therewith in a dry state for 1 hour.

Then, the resulting mixture was heated in the platinum crucible at a temperature of 950° C. for 8 hours. The heating was conducted on a first stage from a room temperature up to the temperature of 700° C. at a temperature rising rate of 200° C./h and on a second stage from the temperature of 700° C. up to the temperature of 950° C. at a temperature rising rate of 50° C./h. Thereafter, the resulting mixture was cooled to the room temperature at a temperature drop rate of 150° C./h, thereby obtaining a reacted substance.

Subsequently, the reacted substance was subjected to hot water washing to remove the flux in the same maimer as that of Example 1. In such away, a powder was obtained in a composition of Na(Nb_{0.9}Ta_{0.1})O₃. The powder of Na(Nb_{0.9}Ta_{0.1})O₃ was a plate-like powder particle, having excellent surface smoothing capability with a pseudocubic {100} plane placed on a maximal plane (oriented plane), which had an average particle diameter of 12 μm and an aspect ratio of approximately 10 to 20 μm.

Thereafter, powders of KHCO₃, Nb₂O₅ and Ta₂O₅ were added as a source of K, a source of Nb and a source of Ta, respectively, to the powder of Na(Nb_{0.9}Ta_{0.1})O₃ to provide a blend, which was mixed in a dry state. During such blending, the source of K, the source of Nb and the source of Ta were blended in an atomic ratio of K:Nb:Ta=1:0.9:0.1 such that Na in powder of Na(Nb_{0.9}Ta_{0.1})O₃ and K in the source of K had an atomic ratio of 0.55:0.45. Then, 80 wt. parts of KCl was added as a flux to 100 wt. parts of the resulting mixture for mixing in a dry state for 1 hour.

Subsequently, the resulting mixture was heated in the platinum crucible at a temperature of 1025° C. for 12 hours, thereby synthesizing a compound of (K_{0.65}Na_{0.35})(Nb_{0.9}Ta_{0.1})O₃. The heating was conducted on a first stage from a room temperature up to a temperature of 700° C. at a temperature rising rate of 200° C./h and further conducted on a second stage from the temperature of 700° C. up to a temperature of 1025° C. at a temperature rising rate of 50° C./h. Thereafter, the resulting mixture was cooled to the room temperature at a temperature drop rate of 150° C./h, thereby obtaining a reacted substance. Subsequently, the reacted substance was subjected to hot water washing to remove the flux.

The reacted substance included a plate-like powder and a fine powder in a mixed state. A componential analysis and crystal phase of the reacted substance (mixed powder) were analyzed using the energy dispersive X-ray analyzer (EDX) and the X-ray diffractometry (XRD) in the same manner as those analyzed in Example 2. As a result, the plate-like powder was a perovskite compound including a principal component of a powder of (K_{0.65}Na_{0.35})(Nb_{0.9}Ta_{0.1})O₃ and the fine powder was a perovskite compound in a principal component of (K_{0.7}Na_{0.3})(Nb_{0.9}Ta_{0.1})O₃.

Then, the fine powder was removed from the mixed powder by air separation, thereby obtaining an anisotropically shaped powder composed of the plate-like powder having a principal composition of ((K_{0.65}Na_{0.35})(Nb_{0.9}Ta_{0.1})O₃ powder). The anisotropically shaped powder was a plate-like powder, having excellent surface smoothing capability with a pseudocubic plane {100} placed in a maximal plane (oriented plane), which had an average particle diameter of approximately 12 μm and an aspect ratio of approximately 10 to 20 μm.

Next, a crystal oriented ceramics was manufactured in the same manner as that of Example 1 using the anisotropically shaped powder of (K_{0.65}Na_{0.35})(Nb_{0.9}Ta_{0.1})O₃ prepared in this Example. That is, the crystal oriented ceramics of this Example was composed of a polycrystal substance with a main phase formed in an isotropic perovskite-based compound of (Li_{0.06}K_{0.423}Na_{0.517})(Nb_{0.835}Ta_{0.1}Sb_{0.065})O₃ like that of Example 1 with a plane {100}of each crystal grain constituting the polycrystal substance being oriented.

More particularly, first, commercially available powders of NaHCO₃, KHCO₃, Li₂CO₃, Nb₂O₅, Ta₂O₅ and NaSbO₃ were weighed in a blend so as to provide a composition wherein 0.05 mol of a powder of (K_{0.65}Na_{0.35})(Nb_{0.9}Ta_{0.1})O₃, used as the anisotropically shaped powder, was subtracted from 1 mol of stoichiometric composition of (Li_{0.06}K_{0.423}Na_{0.517})(Nb_{0.835}Ta_{0.1}Sb_{0.065})O₃ forming a target composition when sintering the anisotropically shaped powder and the reactive raw material. This blend was then mixed in medium, such as an organic solvent, in a wet state in the same manner as that of Example 1. The resulting mixture was provisionally fired, after which the resulting mixture was further pulverized in a wet state, thereby obtaining a provisionally fired substance powder (reactive raw material) with an average particle diameter of approximately 0.5 μm.

The reactive raw material and the anisotropically shaped powder of ((K_{0.65}Na_{0.35})(Nb_{0.9}Ta_{0.1})O₃ powder) were weighed in stoichiometric ratio so as to provide a mixture capable of forming a compound in a composition of (Li_{0.06}K_{0.423}Na_{0.517})(Nb_{0.835}Ta_{0.1}Sb_{0.065})O₃ when sintered. More particularly, the anisotropically shaped powder and the reactive raw material were weighed in a molar ratio of 0.05:0.95 (anisotropically shaped powder:reactive raw material) to provide a blend. Then, the blend was mixed in medium to prepare a slurry-like raw material mixture in the same way as that of Example 1. This slurry-like raw material mixture was shaped in a compact body in the same manner as that of Example 1, after which the compact body was subjected to the degreasing step.

Next, the compact body, resulting from the degreasing step, was fired in the same manner as that of Example 1, thereby obtaining a crystal oriented ceramics. This ceramics was treated as a specimen E4. In addition, the firing step was conducted on the same firing pattern as that of Example 1 with the temperature rising rate of 200° C./h and the cooling rate of 200° C./h except for a sintering temperature of 1140° C.

A bulk density and orientation degree of the crystal oriented ceramics of the specimen E4, manufactured in this Example, were measured in the same way as that of Example 1. The measured results were indicated in Table 1 described below.

### EXAMPLE 5

In this Example, the manufacturing method was implemented to manufacture a compound with d=0.32 and b=0.05 in the general formula (4): (K_{d}Na_{1-d})(Nb_{1-b}Ta_{b})O₃ (wherein 0<d≦0.8 and 0.02≦b≦0.4), that is, an anisotropically shaped powder having a principal component of (K_{0.32}Na_{0.68})(Nb_{0.95}Ta_{0.05})O₃ and including oriented grains with a specific crystal plane {100} of each oriented grain being oriented.

In this Example, the preparing step and the heating step were carried out in the same manner as those of Example 3 to prepare the anisotropically shaped powder.

More specifically, first, a plate-like Na(Nb_{0.93}Ta_{0.07})O₃ powder with an average particle diameter of 12 μm was prepared in the same manner as that of Example 1.

Thereafter, the Na(Nb_{0.93}Ta_{0.07})O₃ powder was used as an anisotropically shaped raw material powder, to which powders of KHCO₃ and Nb₂O₅ were added as a source of K and a source of Nb, respectively, for mixing in a dry state. During such blending, the source of K and the source of Nb were added in an atomic ratio of K:Nb=1:1 and an atomic ratio of 0.55:0.45 for Na in powder of Na(Nb_{0.93}Ta_{0.07})O₃ and K in the source (KHCO₃) of K. Then, 80 wt. parts of KCl was added as a flux to 100 wt. parts of the resulting mixture and mixed in a dry state for 1 hour.

Subsequently, the resulting mixture was heated in the platinum crucible at a temperature of 1025° C. for 12 hours. The heating was conducted on a first stage from a room temperature up to a temperature of 700° C. at a temperature rising rate of 200° C./h and further conducted on a second stage from the temperature of 700° C. up to the temperature of 1025° C. at a temperature rising rate of 50° C./h. Thereafter, the resulting mixture was cooled to the room temperature at a temperature drop rate of 150° C./h, thereby obtaining a reacted substance. Subsequently, the reacted substance was subjected to hot water washing to remove the flux.

The reacted substance included a plate-like powder and a fine powder in a mixed state. Like Example 2, a componential analysis of the reacted substance (mixed powder) was analyzed using the energy dispersive X-ray analyzer (EDX) and a crystal phase of the same was identified using the X-ray diffractometry (XRD). As a result, the plate-like powder was a perovskite compound including a principal component of a powder of (K_{0.32}Na_{0.68})(Nb_{0.95}Ta_{0.05})O₃.

Then, the fine powder was removed from the mixed powder by air separation, thereby obtaining an anisotropically shaped powder composed of the plate-like powder having a principal composition of ((K_{0.32}Na_{0.68})(Nb_{0.95}Ta_{0.05})O₃ powder). The anisotropically shaped powder was a plate-like powder with excellent surface smoothing capability having a pseudocubic plane {100} placed in a maximal plane (oriented plane) with an average particle diameter of approximately 12 μm and an aspect ratio of approximately 10 to 20 μm.

FIG. 4 shows a scanning electron microscope image of the anisotropically shaped powder prepared in this Example.

Next, a crystal oriented ceramics was manufactured in the same structure as that of Example 1 using the anisotropically shaped powder of ((K_{0.32}Na_{0.68})(Nb_{0.95}Ta_{0.05})O₃ powder) prepared in this Example. That is, the crystal oriented ceramics of this Example was composed of a polycrystal substance with a main phase formed in an isotropic perovskite-based compound of (Li_{0.06}K_{0.423}Na_{0.517})(Nb_{0.835}Ta_{0.1}Sb_{0.065})O₃ like that of Example 1 with a plane {100} of each crystal grain constituting the polycrystal substance being oriented.

More particularly, first, commercially available powders of NaHCO₃, KHCO₃, Li₂CO₃, Nb₂O₅, Ta₂O₅ and NaSbO₃ were weighed so as to provide a composition in which 0.05 mol of (K_{0.32}Na_{0.68})(Nb_{0.95}Ta_{0.05})O₃ powder, used as the anisotropically shaped powder, was subtracted from 1 mol of stoichiometric composition of (Li_{0.06}K_{0.423}Na_{0.517})(Nb_{0.835}Ta_{0.1}Sb_{0.065})O₃ forming a target composition when sintering the anisotropically shaped powder and the reactive raw material. The resulting blend was then mixed in medium, such as an organic solvent, in a wet state in the same manner as that of Example 1. The resulting mixture was provisionally fired, after which the resulting mixture was pulverized in a wet state, thereby obtaining a provisionally fired substance (reactive raw material) with an average particle diameter of approximately 0.5 μm.

The reactive raw material and the anisotropically shaped powder of ((K_{0.32}Na_{0.68})(Nb_{0.95}Ta_{0.05})O₃ powder) were weighed in stoichiometric ratio in the same manner as that of Example 1 so as to provide a composition of (Li_{0.06}K_{0.423}Na_{0.517})(Nb_{0.835}Ta_{0.1}Sb_{0.065})O₃ when sintered. More particularly, the anisotropically shaped powder and the reactive raw material were weighed in a molar ratio of 0.05:0.95 (anisotropically shaped powder:reactive raw material) to provide a blend. Then, the blend was mixed in medium to prepare a slurry-like raw material mixture in the same way as that of Example 1. This slurry-like raw material mixture was shaped into a compact body in the same manner as that of Example 1, after which the compact body was subjected to the degreasing step.

Next, the compact body, resulting from the degreasing step, was fired in the same manner as that of Example 1, thereby obtaining a crystal oriented ceramics. This ceramics was treated as a specimen E5. In addition, the heating and the cooling were conducted in the firing step on the same firing pattern as that of Example 1 with the temperature rising rate of 200° C./h and the cooling rate of 200° C./h.

A bulk density and orientation degree of the crystal oriented ceramics of the specimen E5, manufactured in this Example, were measured in the same way as that of Example 1. The measured results were indicated in Table 1 described below.

### COMPARATIVE EXAMPLE 1

In this Comparative Example, an anisotropically shaped powder was manufactured in a composition of NaNbO₃.

First, powders of Bi₂O₃, NaHCO₃ and Nb₂O₅ were weighed in a stoichiometric ratio in a composition of Bi_{2.5}Na_{3.5}Nb₅O₁₈, upon which these substances were mixed in a wet process. Subsequently, 80 wt. parts of NaCl was added as a flux to 100 wt. parts of the resulting mixture, upon which the resulting substance was mixed in a dry state for 1 hour.

Thereafter, the resulting mixture was placed in the platinum crucible and heated at a temperature of 1100° C. for 2 hours in the same manner as that of Example 1, thereby synthesizing a compound in a composition of Bi_{2.5}Na_{3.5}Nb₅O₁₈. The resulting reactive substance was subjected to hot water washing to remove a flux in the same manner as that of Example 1, upon which the reacted substance was pulverized using a jet mill. In such a way, a Bi_{2.5}Na_{3.5}Nb₅O₁₈ powder was obtained. The resulting Bi_{2.5}Na_{3.5}Nb₅O₁₈ powder was a plate-like powder, having a plane {001 } placed in an oriented plane (in a maximal plane), which had an average particle diameter of approximately 12 μm with an aspect ratio of approximately 10 to 20 μm.

Subsequently, 2 mol of NaHCO₃ powder was added to 1 mol of Bi_{2.5}Na_{3.5}Nb₅O₁₈ powder for mixing in a dry state. 80 wt. parts of NaCl was added as a flux to 100 wt. parts of the resulting mixture for mixing in a dry state for 1 hour.

Next, the resulting mixture was heated in the platinum crucible at a temperature of 950° C. for 8 hours in the same manner as that of Example 1, synthesizing a reacted substance. The reacted substance was subjected to hot water washing to remove the flux, after which Bi₂O₃ was removed.

In such away, an anisotropically shaped powder was obtained including a powder of NaNbO₃. This anisotropically shaped powder was a plate-like powder, having a pseudocubic {100} plane placed on a maximal plane (oriented plane), which had an average particle diameter of 12 μm and an aspect ratio of approximately 10 to 20 μm.

FIG. 5 shows a scanning electron microscope image of the anisotropically shaped powder prepared in this Comparative Example.

Then, a crystal oriented ceramics was fabricated using the resulting anisotropically shaped powder (NaNbO₃ powder) prepared in this Comparative Example. That is, a crystal oriented ceramics of the Comparative Example included a polycrystal substance with a main phase having an isotropic perovskite-based compound in the same composition of (Li_{0.06}K_{0.423}Na_{0.517})(Nb_{0.835}Ta_{0.1}Sb_{0.065})O₃ as that of Example 1, with a crystal plane {100} of each crystal grain constituting the polycrystal being oriented.

More particularly, first, commercially available powders of NaHCO₃, KHCO₃, Li₂CO₃, Nb₂O₅, Ta₂O₅ and NaSbO₃ were weighed so as to provide a composition in which 0.05 mol of NaNbO₃ powder, used as the anisotropically shaped powder, was subtracted from 1 mol of stoichiometric composition of (Li_{0.06}K_{0.423}Na_{0.517})(Nb_{0.835}Ta_{0.1}Sb_{0.065})O₃ forming a target composition when sintering the anisotropically shaped powder and the reactive raw material. This blend was then mixed in medium such as an organic solvent in a wet state like Example 1. The resulting mixture was provisionally fired and further pulverized in a wet process, thereby obtaining a provisionally fired powder substance (reactive raw material) with an average particle diameter of approximately 0.5 μm.

The reactive raw material and the anisotropically shaped powder were weighed in stoichiometric ratio so as to provide a compound of (Li_{0.06}K_{0.423}Na_{0.517})(Nb_{0.835}Ta_{0.1}Sb_{0.065})O₃ when sintered. More particularly, the anisotropically shaped powder and the reactive raw material were weighed in a molar ratio of 0.05:0.95 (anisotropically shaped powder:reactive raw material) to provide a blend. Then, the blend was mixed in an organic solvent to obtain a slurry-like raw material mixture in the same manner as that of Example 1. This slurry-like raw material mixture was shaped in a compact and degreased in the same manner as that of Example 1.

Then, the compact body, resulting from the degreasing step, was fired on the same firing pattern as that of Example 1, thereby obtaining a crystal oriented ceramics. This ceramics was treated as a specimen C1.

### COMPARATIVE EXAMPLE 2

In this Comparative Example, further, a compact body was prepared using the same anisotropically shaped powder and the reactive raw material as those of the specimen C1. Then, the compact body was press rolled. Thereafter, the resulting compact body was degreased and, then, subjected to CIP treatment, thereby obtaining a crystal oriented ceramics as a specimen C2.

In particular, first, the anisotropically shaped powder (NaNbO₃ powder and the reactive material), used for preparing the specimen C1, were prepared, after which a slurry-like raw material mixture was prepared in the same way as that of Example 1. Then, the slurry-like raw material mixture was shaped and stacked in the same manner as those of Example 1, thereby obtaining a compact body.

The, the resulting compact body, formed in a stacked state, was press rolled and subsequently subjected to a degreasing step in the same manner as those of Example 1. Thereafter, the compact body, resulting from the degreasing step, was subjected to a cold isostatic press (CIP) treatment.

Thereafter, the resulting compact body was fired in the same manner as that of Example 1, thereby obtaining a crystal oriented ceramics. This was treated as a specimen C2.

Apparent densities and orientation degrees of the crystal oriented ceramics of the specimens C1 and C2, prepared in the Comparative Examples 1 and 2, were measured. The results are indicated in Table 1 described below.

### EXAMPLE 6

In this Example, the manufacturing method was carried out to manufacture a compound was manufactured in a composition with f=0.25 in the general formula (8): (K_{f}Na_{1-f})NbO₃ (wherein 0<f≦0.8), that is, an anisotropically shaped powder having a principal component of (K_{0.25}Na_{0.75})NbO₃ and including oriented grains with a specific crystal plane {100} of each oriented grain being oriented.

In this Example, the preparing step and the heating step were carried out to prepare the anisotropically shaped powder.

In the preparing step, an anisotropically shaped starting raw material powder was prepared in a principal component of NaNbO₃ including oriented grains with a specific crystal plane {100} of each oriented grain being oriented.

During the heating step, further, at least a source of K is added to the anisotropically shaped starting raw material powder and the resulting mixture is heated in a flux including a principal component of KCl. This resulted in the production of the anisotropically shaped powder having a principal component of (K_{0.25}Na_{0.75})NbO₃ and including oriented grains with a crystal plane {100} of each oriented grain being oriented. In the heating step, moreover, the anisotropically shaped starting raw material powder was added with, in addition to the source of K, a source of Nb and the resulting mixture was heated.

More particularly, first, a plate-like NaNbO₃ powder was prepared in a composition with an average diameter of 12 μm as the anisotropic raw material powder in the same manner as those of Comparative Examples set forth above.

Next, powders of KHCO₃ and Nb₂O₅ were added as the source of K and the source of Nb, respectively, to the anisotropic raw material powder and the resulting blend was mixed in a dry state. In the mixing step, the source of K and the source of Nb were blended in an atomic ratio of K:Nb=1:1 such that Na in the powder of NaNbO₃ and K in the source of K had a ratio of 0.55:0.45. Subsequently, 80 wt. parts of KCl was added as a flux to 100 wt. parts of the resulting mixture, upon which the resulting substance was mixed in a dry state for 1 hour.

Thereafter, the resulting mixture was placed in a platinum crucible and heated at a temperature of 1025° C. for 12 hours, synthesizing a compound of (K_{0.25}Na_{0.75})NbO₃. The heating was conducted on a first stage from a room temperature up to a temperature of 700° C. at a temperature rising rate of 200° C./h and further conducted on a second stage from the temperature of 700° C. up to a temperature of 1025° C. at a temperature rising rate of 50° C./h. Subsequently, the resulting compound was cooled to the room temperature at a temperature drop rate of 150° C./h, thereby obtaining a reacted substance. Then, the resulting reacted substance was subjected to hot water washing to remove the flux.

The resulting reacted substance included a plate-like powder and a fine powder. A componential analysis of the resulting reacted substance (mixed powder) was conducted using the energy dispersive X-ray analyzer (EDX) and a crystal phase was identified using the X-ray diffractometry (XRD) in the same way as those of Example 2. As a result, it was turned out that the plate-like powder was composed of a perovskite compound having a principal component of (K_{0.25}Na_{0.75})NbO₃ and the fine powder was composed of a perovskite compound having a principal component of (K_{0.7}Na_{0.3})NbO₃.

Then, the fine powder was removed from the mixed powder by air separation, thereby obtaining an anisotropically shaped powder composed of the plate-like powder with a principal composition of ((K_{0.25}Na_{0.75})NbO₃ powder). The anisotropically shaped powder was in a plate-like powder having a pseudocubic plane {100} placed in a maximal plane (oriented plane) with an average particle diameter of approximately 12 μm and an aspect ratio of approximately 10 to 20 μm.

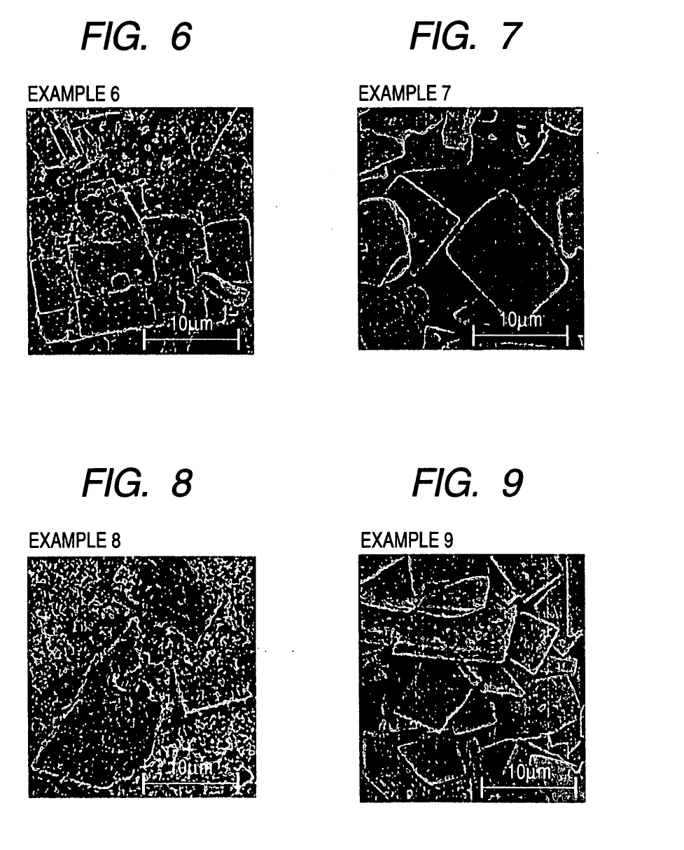

FIG. 6 shows a scanning electron microscope image of the anisotropically shaped powder prepared in this Example.

Next, a crystal oriented ceramics was manufactured in the same composition as that of Example 1 using the anisotropically shaped powder of ((K_{0.25}Na_{0.75})NbO₃ powder) prepared in this Example. That is, the crystal oriented ceramics of this Example was composed of a polycrystal substance with a main phase formed in an isotropic perovskite-based compound of (Li_{0.06}K_{0.423}Na_{0.517})(Nb_{0.835}Ta_{0.1}Sb_{0.065})O₃ like that of Example 1 with a plane {100} of each crystal grain constituting the polycrystal substance being oriented.

More particularly, first, commercially available powders of NaHCO₃, KHCO₃, Li₂CO₃, Nb₂O₅, Ta₂O₅ and NaSbO₃ were weighed to provide a composition in which 0.05 mol of a powder of (K_{0.25}Na_{0.75})NbO₃, used as the anisotropically shaped powder, is subtracted from 1 mol of stoichiometric composition of (Li_{0.06}K_{0.423}Na_{0.517})(Nb_{0.835}Ta_{0.1}Sb_{0.065})O₃ forming a target composition when sintering the anisotropically shaped powder and a reactive raw material. This blend was then mixed in medium, such as an organic solvent, in a wet state in the same way as that of Example 1. The resulting mixture was provisionally fired, after which the resulting mixture was pulverized in a wet state, thereby obtaining a provisionally fired substance (reactive raw material) with an average particle diameter of approximately 0.5 μm.

The reactive raw material and the anisotropically shaped powder ((K_{0.25}Na_{0.75})NbO₃ powder) were weighed in stoichiometric ratio so as to provide a mixture in a composition of (Li_{0.06}K_{0.423}Na_{0.517})(Nb_{0.835}Ta_{0.1}Sb_{0.065})O₃ when sintered. More particularly, the anisotropically shaped powder and the reactive raw material were weighed in a molar ratio of 0.05:0.95 (anisotropically shaped powder:reactive raw material) to provide a blend. Then, the blend was mixed in medium to prepare a slurry-like raw material mixture in the same way as that of Example 1. This slurry-like raw material mixture was shaped into a compact body in the same manner as that of Example 1, after which the compact body was subjected to the degreasing step.

Next, the compact body was fired in the same manner as that of Example 1, thereby obtaining a crystal oriented ceramics. This ceramics was treated as a specimen E6.

A bulk density and orientation degree of the crystal oriented ceramics of the specimen E6, manufactured in this Example, were measured in the same way as that of Example 1. The results were indicated in Table 1 described below.

### EXAMPLE 7

In this Example, the manufacturing method was carried out to manufacture a compound with a=0.45 in a general formula (6): (KₐNa₁₋ₐ)NbO₃ (wherein 0≦a≦0.8), that is, an anisotropically shaped powder in a principal component of (K_{0.45}Na_{0.55})NbO₃ and including oriented grains with a specific crystal plane {100} of each oriented grain being oriented.

In this Example, the acid-treating step and the heating step were carried out to prepare the anisotropically shaped powder.

In the acid-treating step, an anisotropically shaped starting raw material powder was prepared in a composition of a bismuth-layer-like perovskite-based compound represented by a general formula (7): (Bi₂O₂)²⁺(Bi_{0.5}(K_{c}Na_{1-c})_{m-1.5}(NbₘO₃ₘ₊₁)²⁻ (wherein “m” is an integer number greater than 2, 0≦c≦0.8). The starting raw material powder was subjected to acid treatment to obtain an acid-treated substance. In this Example, for the anisotropically shaped starting raw material powder of the bismuth-layer-like perovskite-based compound, use was made of a compound with m=5 and c=0 in the general formula (7), that is, an anisotropically shaped starting raw material powder in a composition of Bi_{2.5}Na_{3.5}Nb₅O₁₈.

In the heating step, furthermore, at least a source of K and/or a source of Na were added to the acid-treated substance. The resulting mixture was heated in a flux including a principal component composed of NaCl and/or KCl. This resulted in an anisotropically shaped powder in a principal component of (K_{0.45}Na_{0.55})NbO₃ and including oriented grains with a specific crystal plane {100} of each oriented grain being oriented.

More particularly, first, a plate-like powder of Bi_{2.5}Na_{3.5}Nb₅O₁₈ with an average particle diameter of 12 μm was prepared in the same manner as that of Comparative Examples mentioned above.

Then, 6N HCl was added in an amount of 30 ml to 1 g of the starting raw material powder and stirred at a temperature of 60° C. for 24 hours. Thereafter, the resulting mixture was filtered in suction to obtain an acid-treated substance of Bi_{2.5}Na_{3.5}Nb₅O₁₈ powder.

Subsequently, a powder of KHCO₃ was added as a source of K to the acid-treated substance. The powder of KHCO₃ was added in a molar ratio of 1.66 mol to 1 mol of the acid-treated substance. Then, 80 wt. parts of KCl was added as a flux to 100 wt. parts of a mixture between the acid-treated substance and the source of K and mixed in a dry state for 1 hour. Thereafter, the resulting mixture was heated in the platinum crucible at a temperature of 1000° C. for 8 hours. The heating was conducted on a first stage from a room temperature up to a temperature of 700° C. at a temperature rising rate of 200° C./h and further conducted on a second stage from the temperature of 700° C. up to a temperature of 1000° C. at a temperature rising rate of 50° C./h. Subsequently, the resulting mixture was cooled to a room temperature at a temperature drop rate of 150° C./h, thereby obtaining a reacted substance.

The resulting reacted substance was subjected to hot water washing in the same way as that of Example 1 to remove the flux, thereby obtaining an anisotropically shaped powder.

The anisotropically shaped powder was subjected to a componential analysis using the energy dispersive X-ray analyzer (EDX) and a crystal phase of the anisotropically shaped powder was identified using the X-ray diffractometry (XRD). As a result, it was turned out that the anisotropically shaped powder was composed of a perovskite compound including a principal component of (K_{0.45}Na_{0.55})NbO₃. This anisotropically shaped powder was a plate-like powder having a pseudocubic plane {100} placed in a maximal plane (oriented plane) with an average particle diameter of approximately 12 μm and an aspect ratio of approximately 10 to 20 μm.

FIG. 7 shows a scanning electron microscope (SEM) image showing the anisotropically shaped powder prepared in this Example.

Next, a crystal oriented ceramics was manufactured in the composition as that of Example 1 using the anisotropically shaped powder of (K_{0.45}Na_{0.55})NbO₃ prepared in this Example. That is, the crystal oriented ceramics of this Example was composed of the polycrystal substance with the main phase formed in an isotropic perovskite-based compound of (Li_{0.06}K_{0.423}Na_{0.517})(Nb_{0.835}Ta_{0.1}Sb_{0.065})O₃ like Example 1 with a plane {100} of each crystal grain forming the polycrystal substance being oriented.

More particularly, first, commercially available powders of NaHCO₃, KHCO₃, Li₂CO₃, Nb₂O₅, Ta₂O₅ and NaSbO₃ were weighed to provide a composition in which 0.05 mol of (K_{0.45}Na_{0.55})NbO₃ powder is subtracted from 1 mol of stoichiometric composition of (Li_{0.06}K_{0.423}Na_{0.517})(Nb_{0.835}Ta_{0.1}Sb_{0.065})O₃ forming a target composition when sintering the anisotropically shaped powder and the reactive raw material. This blend was then mixed in an organic solvent in a wet state to obtain a mixed powder. The resulting mixed powder was provisionally fired and further pulverized in a wet state, thereby obtaining a provisionally fired powder as a reactive raw material with an average particle diameter of approximately 0.5 μm.

The reactive raw material and the anisotropically shaped powder ((K_{0.45}Na_{0.55})NbO₃ powder) were weighed in stoichiometric ratio so as to provide a compound of (Li_{0.06}K_{0.423}Na_{0.517})(Nb_{0.835}Ta_{0.1}Sb_{0.065})O₃ forming a composition when sintered. More particularly, the anisotropically shaped powder and the reactive raw material were weighed in a molar ratio of 0.05:0.95 (anisotropically shaped powder:reactive raw material) to provide a blend. The blend was mixed in medium to prepare a slurry-like raw material mixture in the same way as that of Example 1. This slurry-like raw material mixture was shaped into a compact body in the same manner as that of Example 1, after which the compact body was subjected to a degreasing step.

Next, the compact body was fired on the same firing pattern as that of Example 1, obtaining a crystal oriented ceramics. This ceramics was treated as a specimen E7. In addition, the heating and cooling steps were carried out on the same firing pattern as that of Example 1 with the temperature rising rate of 200° C./h and the cooling rate of 200° C./h.

A bulk density and orientation degree of the crystal oriented ceramics of the specimen E7, manufactured in this Example, were measured in the same way as that of Example 1. The results are indicated in Table 1 described below.

### EXAMPLE 8

In this Example, the manufacturing method was carried out to manufacture a compound with d=0.67 and b=0.07 in the general formula (4): (K_{d}Na_{1-d})(Nb_{1-b}Ta_{b})O₃ (wherein 0<d≦0.8 and 0.02≦b≦0.4), that is, an anisotropically shaped powder having a principal component of (K_{0.67}Na_{0.33})(Nb_{0.93}Ta_{0.07})O₃ and including oriented grains with a specific crystal plane {100} of each oriented grain being oriented.

In this Example, the preparing step and the heating step were carried out in the same manner as those of Example 3 to prepare an anisotropically shaped powder.

In the preparing step, an anisotropically shaped starting raw material powder was prepared in a principal component of a pentavalent metal acid alkali compound of an isotropic perovskite-based structure, represented by the general formula (5): Na(Nb₁₋ₑTaₑ)O₃ (wherein 0.02≦e≦0.4), which included oriented grains with a specific crystal plane {100} of each grain being oriented.

In this Example, for the anisotropically shaped starting raw material powder, use was made of a compound with e=0.07 in the general formula (5), that is, the anisotropically shaped starting raw material powder in the composition of Na(Nb_{0.93}Ta_{0.07})O₃.

In the heating step, further, at least a source of K was added to the anisotropically shaped starting raw material powder. The resulting mixture was heated in a flux including the principal component composed of KCl. This resulted in an anisotropically shaped powder in a principal component of (K_{0.67}Na_{0.33})(Nb_{0.93}Ta_{0.07})O₃ and including oriented grains with a specific crystal plane {100} of each grain being oriented. In the heating step of this Example, furthermore, a powder of KNbO₃ was used as the source of K. The powder of KNbO₃ played a role as not only the source of K but also the source of Nb.

More particularly, first, the anisotropically shaped starting raw material powder was prepared. For the anisotropically shaped starting raw material powder, use was made of the anisotropically shaped powder in the composition of Na(Nb_{0.93}Ta_{0.07})O₃ prepared in Example 1.

The powder of KNbO₃ was added as the sources of K and Nb to the Na(Nb_{0.93}Ta_{0.07})O₃ powder, after which the resulting blend was mixed in a dry state. During such blending, the powder of KNbO₃ was added such that Na in the Na(Nb_{0.93}Ta_{0.07})O₃ powder and K in the KNbO₃ powder had an atomic ratio of 0.55:0.45. Thereafter, 80 wt. parts of KCl was added as a flux to 100 wt. parts of the resulting mixture, upon which the resulting mixture was mixed in a dry state for 1 hour.

Then, the resulting mixture was heated in the platinum crucible at a temperature of 1050° C. for 12 hours, thereby synthesizing a compound of (K_{0.67}Na_{0.33})(Nb_{0.93}Ta_{0.07})O₃. The heating was conducted on a first stage from a room temperature up to a temperature of 700° C. at a temperature rising rate of 200° C./h and further conducted on a second stage from the temperature of 700° C. up to a temperature of 1050° C. at a temperature rising rate of 50° C./h. Thereafter, the resulting mixture was cooled to the room temperature at a temperature drop rate of 150° C./h, thereby obtaining a reacted substance. Subsequently, the reacted substance was subjected to hot water washing to remove the flux.

The reacted substance included a plate-like powder and a fine powder in a mixed state. The reacted substance (mixed powder) was subjected to a componential analysis using the energy dispersive X-ray analyzer (EDX) and a crystal phase of the reacted substance was identified using the X-ray diffractometry (XRD) in the same way as that of Example 2. As a result, the plate-like powder was a perovskite compound including a principal component of a powder of (K_{0.67}Na_{0.33})(Nb_{0.93}Ta_{0.07})O₃.

Then, the fine powder was removed from the mixed powder by air separation, thereby obtaining an anisotropically shaped powder composed of the plate-like powder having a principal composition of (K_{0.67}Na_{0.33})(Nb_{0.93}Ta_{0.07})O₃. The anisotropically shaped powder appeared in a plate-like powder having a pseudocubic plane {100} placed in a maximal plane (oriented plane) with an average particle diameter of approximately 12 μm and an aspect ratio of approximately 10 to 20 μm.

FIG. 8 shows a scanning electron microscope image of the anisotropically shaped powder prepared in this Example.

Next, a crystal oriented ceramics was manufactured in the same manner as that of Example 1 using the anisotropically shaped powder of ((K_{0.67}Na_{0.33})(Nb_{0.93}Ta_{0.07})O₃ powder) prepared in this Example. That is, the crystal oriented ceramics of this Example was composed of a polycrystal substance having a main phase formed in an isotropic perovskite-based compound of (Li_{0.06}K_{0.423}Na_{0.517})(Nb_{0.835}Ta_{0.1}Sb_{0.065})O₃ like that of Example 1 with a plane {100} of each crystal grain constituting the polycrystal substance being oriented.

More particularly, first, commercially available powders of NaHO₃, KHCO₃, Li₂CO₃, Nb₂O₅, Ta₂O₅ and NaSbO₃ were weighed to provide a composition wherein 0.05 mol of (K_{0.67}Na_{0.33})(Nb_{0.93}Ta_{0.07})O₃ powder, used as the anisotropically shaped powder, was subtracted from 1 mol of stoichiometric composition of (Li_{0.06}K_{0.423}Na_{0.517})(Nb_{0.835}Ta_{0.1}Sb_{0.065})O₃ forming a target composition when sintering the anisotropically shaped powder and the reactive raw material. This blend was then mixed in an organic solvent in a wet state in the same manner as that of Example 1. The resulting mixture was provisionally fired, after which the resulting mixture was pulverized in a wet state. This resulted in a provisionally fired substance (reactive raw material) with an average particle diameter of approximately 0.5 μm.

The reactive raw material and the anisotropically shaped powder ((K_{0.67}Na_{0.33})(Nb_{0.93}Ta_{0.07})O₃ powder) were weighed in stoichiometric ratio so as to provide a compound of (Li_{0.06}K_{0.423}Na_{0.517})(Nb_{0.835}Ta_{0.1}Sb_{0.065})O₃ forming a composition when sintered. More particularly, the anisotropically shaped powder and the reactive raw material were weighed in a molar ratio of 0.05:0.95 (anisotropically shaped powder:reactive raw material) to provide a blend. Then, the blend was mixed in medium to prepare a slurry-like raw material mixture in the same way as that of Example 1. This slurry-like raw material mixture was shaped into a compact body in the same manner as that of Example 1, after which the compact body was subjected to the degreasing step.

Next, the compact body, resulting from the degreasing step, was fired on the same firing pattern as that of Example 1, thereby obtaining a crystal oriented ceramics. This ceramics was treated as a specimen E8.

A bulk density and orientation degree of the crystal oriented ceramics of the specimen E8, manufactured in this Example, were measured in the same way as that of Example 1. The results are indicated in Table 1 described below.

### EXAMPLE 9

In this Example, an anisotropically shaped starting raw material powder was prepared in a composition composed of a bismuth-layer-like perovskite-based compound represented by a general formula (9): (Bi₂O₂)²⁺{Bi_{0.5}(K_{c}Na_{1-c})_{m-1.5}(Nb_{1-g}Ta_{g})ₘO₃ₘ₊₁}²⁻ (wherein “m” is an integer number greater than 2, 0≦c≦0.8 and 0≦g≦0.4). The resulting anisotropically shaped starting raw material powder was then acid treated to obtain an anisotropically shaped powder. Using the anisotropically shaped powder allows the crystal oriented ceramics to be manufactured.

That is, in Examples 2 and 7, the acid-treatment was conducted and subsequently the heating step was conducted thereby preparing the anisotropically shaped powder. In this Example, however, no heating step was conducted and only the acid-treatment was conducted, thereby obtaining the anisotropically shaped powder.

Hereunder, a method of manufacturing a crystal oriented ceramics of this Example is described below in detail. First, the anisotropically shaped powder was prepared in a manner described below.

That is, first, Bi_{2.5}Na_{3.5}(Nb_{0.93}Ta_{0.07})₅O₁₈ powder, prepared in Example 1, was prepared as the anisotropically shaped starting raw material powder in the composition of Bi_{2.5}Na_{3.5}(Nb_{0.93}Ta_{0.07})₅O₁₈.

Subsequently, 6N HCl was added in an amount of 30 ml to 1 g of the starting raw material powder, upon which the resulting substance was stirred in a beaker at a temperature of 60° C. for 24 hours. Thereafter, the resulting substance was filtered in suction. Such acid washing steps were repeatedly conducted multiple times (two times in this Example), thereby obtaining an acid-treated substance in the form of a Bi_{2.5}Na_{3.5}(Nb_{0.93}Ta_{0.07})₅O₁₈ powder.

A crystal phase of such an anisotropically shaped powder was identified using the X-ray analyzing device (XRD). As a result, it has been turned out that the anisotropically shaped powder was a complicated structure containing a perovskite compound structure with the inclusion of a major component composed of a powder represented by Na_{0.5}(Nb_{0.93}Ta_{0.07})O₃ when assumed to be the perovskite-based compound. The anisotropically shaped powder was a plate-like powder with excellent surface smoothing capability having an average particle diameter of approximately 12 μm and an aspect ratio of about 10 to 20.

FIG. 9 shows a scanning electron microscope (SEM) image showing the anisotropically shaped powder prepared in this Example.

Next, the crystal oriented ceramics was prepared using this anisotropically shaped powder.

More particularly, first, the anisotropically shaped powder, prepared in this Example, and the reactive raw material, prepared in Example 1, were weighed in a molar ratio of 0.05:0.95 (anisotropically shaped powder:reactive raw material) to provide a blend. Then, the blend was mixed, thereby preparing a slurry-like raw material mixture in the same way as that of Example 1. Thereafter, the slurry-like raw material mixture was shaped into a compact body in the same manner as that of Example 1, after which the degreasing step was conducted.

Next, the resulting compact obtained upon the degreasing step was placed on a Pt plate in a magnesia bowl and heated in atmosphere at a temperature of 1120° C. for 5 hours for firing. Subsequently, the compact body was cooled, thereby obtaining the crystal oriented ceramics. This ceramics was treated as a specimen E9. In addition, the heating and cooling steps were carried out on a firing pattern at a temperature rising rate of 200° C./h with a cooling rate of 10° C./h for temperatures ranging from 1120 to 1000° C. and a cooling rate of 200° C./h for temperatures below 1000° C.

A bulk density and orientation degree of the crystal oriented ceramics of the specimen E9, prepared in this Example, were measured in the same way as that of Example 1. The results are indicated in Table 1 described below.

TABLE 1

| | | | Crystal- | |
|---|---|---|---|---|
| | | Press- | Oriented | |
| | | Rolling | Ceramics | |
| | | and | | Orien- |
| | | CIP | Bulk | tation |
| Specimen | Anisotropically | Treat- | Density | Degree |
| No. | Shaped Powder | ment | (g/cm³) | (%) |
| Specimen | Na (Nb_{0.93}Ta_{0.07})O₃ | x | 4.71 | 92 |
| E1 | | | | |
| Specimen | (K_{0.56}Na_{0.44})(Nb_{0.93}Ta_{0.07})O₃ | x | 4.72 | 89 |
| E2 | | | | |
| Specimen | (K_{0.3}Na_{0.7})(Nb_{0.89}Ta_{0.11})O₃ | x | 4.73 | 95 |
| E3 | | | | |
| Specimen | (K_{0.65}Na_{0.35})(Nb_{0.9}Ta_{0.1})O₃ | x | 4.74 | 93 |
| E4 | | | | |
| Specimen | (K_{0.32}Na_{0.68})(Nb_{0.95}Ta_{0.05})O₃ | x | 4.72 | 93 |
| E5 | | | | |
| Specimen | (K_{0.25}Nb_{0.75})NbO₃ | x | 4.66 | 88 |
| E6 | | | | |
| Specimen | (K_{0.45}Na_{0.55})NbO₃ | x | 4.68 | 88 |
| E7 | | | | |
| Specimen | (K_{0.67}Na_{0.33})(Nb_{0.93}Ta_{0.07})O₃ | x | 4.72 | 92 |
| E8 | | | | |
| Specimen | Na_{0.5}(Nb_{0.93}Ta_{0.07})O₃ | x | 4.73 | 89 |
| E9 | | | | |
| Specimen | NaNbO₃ | x | 4.48 | 76 |
| C1 | | | | |
| Specimen | NaNbO₃ | ∘ | 4.57 | 88 |
| C2 | | | | |

In Table 1, an empty circle “∘” in column “Press-Rolling and CIP Treatment” designates that the “Press-Rolling Step and CIP Treatment Step” were conducted. A symbol “×” represents that none of the Press-Rolling Step and CIP Treatment Step was initiated.

As will be apparent from Table 1, each of the crystal oriented ceramics, belonging to the specimens E1 to E9 obtained in Examples 1 to 9, exhibited higher bulk density and orientation degree than those of the specimen C1. In addition, it will be appreciated that in spite of no implementation of “Press-Rolling Step and CIP Treatment Step”, each of the specimens E1 to E9 exhibited an excellent bulk density and orientation degree at a level equivalent to that of the specimen C2 prepared upon the implementation of “Press-Rolling Step and CIP Treatment Step”.

It will thus be understood that the use of the anisotropically shaped powder obtained din Examples 1 to 9 enables the crystal oriented ceramics to be produced with increased bulk density and increased orientation degree on an excellent mass production basis.

### Experiment

This Experiment represents an example for executing comparative evaluations on the specimen E3, prepared in Example 3, and the specimen C1 prepared in Comparative Example 1 to check variations in composition of the crystal oriented ceramics.

In this Experiment, further, the non-oriented ceramics (specimen C3) was prepared for comparison to the specimen E3, upon which the evaluation was made to check variation in composition of the non-oriented ceramics.

First, the non-oriented ceramics (specimen C3) was prepared in a manner described below.

In particular, first, commercially available powders of NaHCO₃, KHCO₃, Li₂CO₃, Nb₂O₅, Ta₂O₅ and NaSbO₃ were weighed in a stoichiometric ratio to provide a compound of (Li_{0.06}K_{0.423}Na_{0.517})(Nb_{0.835}Ta_{0.1}Sb_{0.065})O₃ forming a composition when sintered. The resulting blend was then mixed in medium such as an organic solvent in a wet state in the same manner as that of Example 1. Thereafter, the resulting mixture was provisionally fired and wet milled, thereby obtaining a provisionally fired powder substance with an average particle diameter of approximately 0.5 μm. The provisionally fired powder substance was then wet milled in medium such as an organic solvent with ZrO₂ balls. Further, a binder (polyvinyl butyral) and a plasticizer (dibutyl phthalate) were added to the provisionally fired powder substance for further mixing. Thus, a slurry-like raw material was obtained.

Next, the slurry-like raw material mixture was tape-cast using a doctor-blading apparatus to obtain green strips each with a thickness of 100 μm. The resulting strips were stacked and pressure bonded to each other, thereby obtaining a compact body in a stacked state with a thickness of 1.2 mm.

Subsequently, the compact body was degreased and the degreased compact was fired in the same process as that in Example 1. In such away, a non-oriented ceramics (specimen C3) was obtained.

Then, component analyses were conducted on the specimen E3 and the specimens C1 and C3 using an X-ray micro analyzer (EPMA).

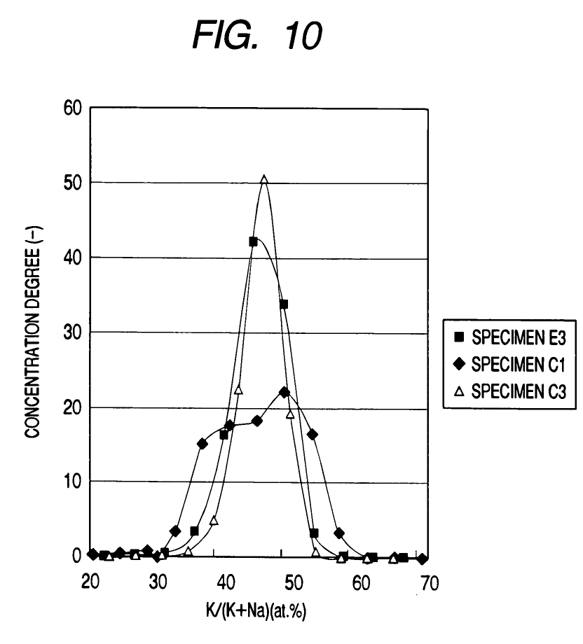

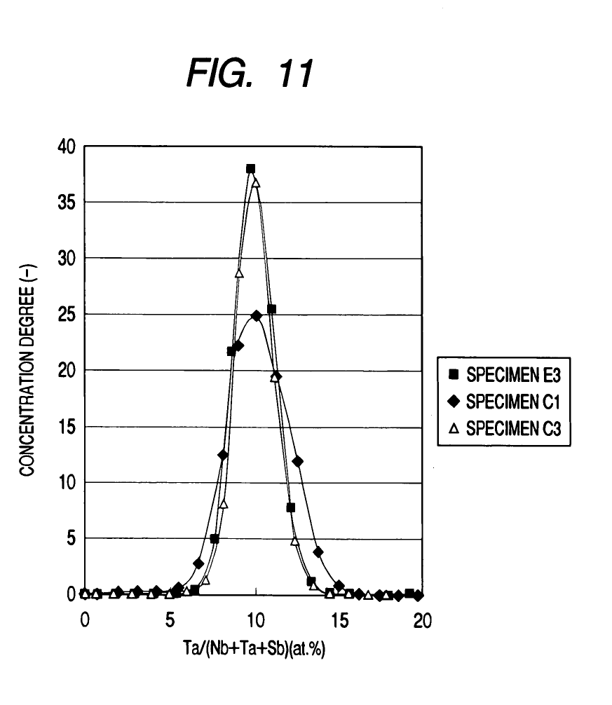

To this end, first, a cross sectional surface perpendicular to a plane {100} of each specimen was grounded. Then, a region of the resulting grounded surface with a surface area of 100 μm×100 μm was split into square-shaped blocks of 256 pieces in a longitudinal direction by 256 in a lateral direction. Then, the concentrations of K and Ta in each block were measured using EPMA. FIGS. 10 and 11 show the concentration distributions of K and Ta.

It will now be turned out from FIGS. 10 and 11 that forming the anisotropically shaped powder in composition closer to the reactive raw material enables the improvement in the crystal oriented ceramics which has a compositional variation at a level nearly equal to that of the non-oriented ceramics. Thus, it becomes possible to obtain the crystal oriented ceramics with superior piezoelectric performance and insulating property than those of the related art.

While the specific embodiments of the present invention have been described above in detail, it will be appreciated by those skilled in the art that various modifications and alternatives to those details could be developed in light of the overall teachings of the disclosure. Accordingly, the particular arrangements disclosed are meant to be illustrative only and not limited to the scope of the present invention, which is to be given the full breadth of the following claims and all equivalents thereof.

1. An anisotropically shaped powder comprising:
an anisotropically shaped powder composed of oriented grains with a specific crystal plane {100} of each crystal grain being oriented; and
the anisotropically shaped powder including a principal component of an isotropic perovskite-based pentavalent metal acid alkali compound represented by a general formula (1): (KₐNa₁₋ₐ)(Nb_{1-b}Ta_{b})O₃ (wherein 0≦a≦0.8 and 0.02≦b≦0.4).

2. The anisotropically shaped powder according to claim 1, wherein:
the anisotropically shaped powder is used for manufacturing a crystal oriented ceramics upon mixing the anisotropically shaped powder with a reactive raw material, reacting with the anisotropically shaped powder, to form a raw material mixture which is then heated to provide the crystal oriented ceramics composed of a polycrystal substance including an isotropic perovskite-based compound with a main phase, represented by a general formula (2): {Liₓ(K_{1-y}Na_{y})₁₋ₓ} (Nb_{1-z-w}Ta_{z}Sb_{w})O₃ (wherein 0≦x≦0.2, 0≦y≦1, 0≦z≦0.4, 0≦w≦0.2 and x+z+w>0), which includes crystal grains with a crystal plane {100} of each crystal grain constituting the polycrystal substance being oriented.

3. The anisotropically shaped powder according to claim 1, wherein:
the anisotropically shaped powder is formed in at least one of a plate-like shape, a columnar shape, a scale-like shape and a needle-like shape.

4. The anisotropically shaped powder according to claim 1, wherein:
the oriented grains have an average aspect ratio equal to or greater than 3 and equal to or less than 100.

5. The anisotropically shaped powder according to claim 1, wherein:
the oriented grains have an average maximal length equal to or less than 30 μm.

6. A method of manufacturing an anisotropically shaped powder having a principal component of an isotropic perovskite-based pentavalent metal acid alkali compound, represented by the general formula (1): (KₐNa₁₋ₐ)(Nb_{1-b}Ta_{b})O₃ (wherein 0≦a≦0.8 and 0.02≦b≦0.4), which has crystal grains with a specific crystal plane {100} of each crystal grain being oriented, the method comprising the steps of:
preparing an anisotropically shaped starting raw material powder composed of a bismuth-layer-like perovskite-based compound represented by a general formula (3): (Bi₂O₂)²⁺{Bi_{0.5}(K_{c}Na_{1-c})_{m-1.5}(Nb_{1-b}Ta_{b})ₘO₃ₘ₊₁}²⁻ (wherein “m” is an integer number greater than 2 and 0≦c≦0.8 and 0.02≦b≦0.4);
acid-treating the anisotropically shaped starting raw material powder for obtaining an acid,treated substance;
adding at least a source of K and/or a source of Na to the acid-treated substance to form a mixture; and
heating the mixture in a flux composed of a principal component containing NaCl and/or KCl for thereby obtaining the anisotropically shaped powder.

7. The method of manufacturing an anisotropically shaped powder according to claim 6, wherein:
the source of K and/or the source of Na are added to the acid-treated substance at a molar ratio of 1 to 5 mol in a sum of an element K and an element Na contained in the source of K and/or source of Na per 1 mol of the bismuth-layer-like perovskite-based compound represented by the general formula (3).

8. A method of manufacturing an anisotropically shaped powder having a principal component of an isotropic perovskite-based pentavalent metal acid alkali compound, represented by a general formula (4): (K_{d}Na_{1-d})(Nb_{1-b}Ta_{b})O₃ (wherein 0<d≦0.8 and 0.02≦b≦0.4), which includes oriented grains with a specific crystal plane {100} of each crystal grain being oriented, the method comprising the steps of:
preparing an anisotropically shaped starting raw material powder, composed of a principal component of an isotropic perovskite-based pentavalent metal acid alkali compound represented by a general formula (5): Na(Nb₁₋ₑTaₑ)O₃ (wherein 0.02≦e≦0.4), which includes oriented grains with a specific crystal plane {100} of each oriented grain being oriented;
adding at least a source of K to the anisotropically shaped starting raw material powder to form a raw material mixture; and
heating the raw material mixture in a flux composed of a principal component containing KCl for thereby obtaining the anisotropically shaped powder.

9. The method of manufacturing an anisotropically shaped powder according to claim 8, wherein:
during the step of heating the raw material mixture, the anisotropically shaped starting raw material powder is further admixed with, in addition to the source of K, a source of Nb and/or a source of Ta.

10. The method of manufacturing an anisotropically shaped powder according to claim 9, wherein:
the source of K, the source of Nb and the source of Ta are added to the anisotropically shaped starting raw material powder in a blending ratio such that an atomic ratio of a sum of an element Nb and an element Ta, contained in the sources, and an atomic ratio of an element K have a ratio of 1:1.

11. A method of manufacturing an anisotropically shaped powder having a principal component, of an isotropic perovskite-based pentavalent metal acid alkali compound, represented by general formula (6): (KₐNa₁₋ₐ)NbO₃ (wherein 0≦a≦0.8), which includes oriented grains with a specific crystal plane {100} of each crystal grain being oriented, the method comprising the steps of:
preparing an anisotropically shaped starting raw material powder, composed of a principal component of a bismuth-layer-like perovskite-based compound represented by a general formula (7): (Bi₂O₂)²⁺(Bi_{0.5}(K_{c}Na_{1-c})_{m-1.5}(NbₘO₃ₘ₊₁)²⁻ (wherein “m” is an integer number greater than 2 and 0≦c≦0.8), which includes oriented grains with a specific crystal plane {100} of each oriented grain being oriented;
acid-treating the anisotropically shaped starting raw material powder for obtaining an acid-treated substance;
adding at least a source of K and/or a source of Na to the acid-treated substance to form an acid-treated mixture; and
heating the acid-treated mixture in a flux composed of a principal component containing NaCl and/or KCl for thereby obtaining the anisotropically shaped powder.

12. The method of manufacturing an anisotropically shaped powder according to claim 11, wherein:
the source of K and/or source of Na are added to the acid-treated substance at a molar ratio of 1 to 5 mol in a sum of the element K and the element Na contained in the source of K and/or source of Na per 1 mol of the bismuth-layer-like perovskite-based compound represented by the general formula (7).

13. A method of manufacturing an anisotropically shaped powder having a principal component of an isotropic perovskite-based pentavalent metal acid alkali compound, represented by a general formula (8): (K_{f}Na_{1-f})NbO₃ (wherein 0<f≦0.8), which includes oriented grains with a specific crystal plane {100} of each crystal grain being oriented, the method comprising the steps of:
preparing an anisotropically shaped starting raw material powder, composed of a principal component of NaNbO₃, which includes oriented grains with a specific crystal plane {100} of each oriented grain being oriented;
adding at least a source of K to the anisotropically shaped starting raw material powder to form a raw material mixture; and
heating the raw material mixture in a flux composed of a principal component containing KCl for thereby obtaining the anisotropically shaped powder.

14. The method of manufacturing an anisotropically shaped powder according to claim 13, wherein:
during the step of heating the raw material mixture, the anisotropically shaped starting raw material powder is further admixed with, in addition to the source of K, a source of Nb.

15. The method of manufacturing an anisotropically shaped powder according to claim 14, wherein:
the source of K and the source of Nb are added to the anisotropically shaped starting raw material powder in a blending ratio such that an atomic ratio of an element K and an atomic ratio of an element Nb, contained in the sources, have a ratio of 1:1.

16. A method of manufacturing a crystal oriented ceramics having a polycrystal substance with a main phase having an isotropic perovskite-based compound, represented by a general formula (2): {Liₓ(K_{1-y}Na_{y})₁₋ₓ} (Nb_{1-z-w}Ta_{z}Sb_{w})O₃ (wherein 0≦x≦0.2, 0≦y≦1, 0≦z≦0.4, 0≦w≦0.2 and x+z+w>0), which includes oriented grains with a specific crystal plane {100} of each crystal grain constituting the polycrystal substance being oriented, the method comprising the steps of:
mixing an anisotropically shaped powder and a reactive material, reacting with the anisotropically shaped powder to provide the isotropic perovskite-based compound represented by the general formula (2), to prepare a raw material mixture;
forming the raw material mixture into a compact body so as to allow the anisotropically shaped powder to have crystal planes {100} oriented in substantially the same direction; and
firing the compact body upon heating the same for reacting the anisotropically shaped powder and the reactive material with each other for sintering to form the crystal oriented ceramics;
wherein the anisotropically shaped powder includes the anisotropically shaped powder defined in claim 1.

17. A method of manufacturing a crystal oriented ceramics, composed of a polycrystal substance with a main phase having an isotropic perovskite-based compound represented by a general formula (2): {Liₓ(K_{1-y}Na_{y})₁₋ₓ} (Nb_{1-z-w}Ta_{z}Sb_{w})O₃ (wherein 0≦x≦0.2, 0≦y≦1, 0≦z≦0.4, 0≦w≦0.2 and x+z+w>0), which includes oriented grains with a specific crystal plane {100} of each crystal grain constituting the polycrystal substance being oriented, the method comprising the steps of:
mixing an anisotropically shaped powder and a reactive material, reacting with the anisotropically shaped powder to provide the isotropic perovskite-based compound represented by the general formula (2), to prepare a raw material mixture;
forming the raw material mixture into a compact body so as to allow the anisotropically shaped powder to have crystal planes {100} oriented in substantially the same direction; and
firing the compact body upon heating the same for reacting the anisotropically shaped powder and the reactive material with each other for sintering to form the crystal oriented ceramics;
wherein the anisotropically shaped powder includes an acid-treated substance obtained by acid treating an anisotropically shaped starting raw material powder composed of a bismuth-layer-like perovskite-based compound represented by a general formula (9): (Bi₂O₂)²⁺{Bi_{0.5}(K_{c}Na_{1-c})_{m-1.5}(Nb_{1-g}Ta_{g})ₘO₃ₘ₊₁}²⁻ (wherein “m” is an integer number greater than 2, and 0≦c≦0.8 and 0≦g≦0.4).

18. The method of manufacturing a crystal oriented ceramics according to claim 17, wherein:
the reactive material includes a non-anisotropically shaped powder composed of an isotropic perovskite-based compound represented by a general formula (10): {Liₓ(K_{1-y}Na_{y})₁₋ₓ} (Nb_{1-z-w}Ta_{z}Sb_{w})O₃ (wherein 0≦x≦1, 0≦y≦1, 0≦z≦1, 0≦w≦1).
